(19) United States
(12) Patent Application Publication
(10) Pub. No.: US 2005/0099255 A1
(43) Pub. Date: May 12, 2005

(54) Transducer with dual coil and dual magnetic gap

(76) Inventor: Fan Zhang, Sichuan Province (CN)

Correspondence Address: FISH & RICHARDSON PC, 225 FRANKLIN ST, BOSTON, MA, 02110, US

(21) Appl. No.: 10/913,018

(22) Filed: Aug. 6, 2004

Related U.S. Application Data
(63) Continuation-in-part of application No. 10/369,141, filed on Feb. 18, 2003, now Pat. No. 6,795,564.
Application No. 10/369,141 is a continuation-in-part of application No. PCT/CN00/00241, filed on Aug. 18, 2000.

(51) Int. Cl. H02K 16/00

(52) U.S. Cl. 335/251

(57) ABSTRACT

A transducer with dual coil and dual magnetic gap of which the upper and lower pole plates of are two inwardly concave plates or round plates. A set or more than1 a piece sets of axially magnetized permanent magnets are provided. Said permanent magnets are engaged with pole faces of said plates. Dual magnetic gap are formed between the vertical faces of said plates and the vertical faces of a coaxial mounted annular or cylindrical magnetic body. Coils are inserted into said magnetic gap, while wound direction of dual coil and the direction of current are decided to produce an electrodynamic force in the coils to the same direction. Said transducer possesses resistance load characteristics by setting the values of the inductance of the dual coil equal to each other in case that said transducer are provided with two magnetic paths and coil circuits completely symmetric in their magnetic characteristics.

### RELATED APPLICATIONS

This application is a continuation-in-part of U.S. application Ser. No. 10/369,141 filed Feb. 18, 2003, the contents of which are incorporated herein by reference.

### FIELD OF INVENTION

The present invention is related to an audio transducer, especially to a transducer with two coaxial magnetic gaps of the same diameters and dual coil belonged to the field of audio transducer in electricity.

### BACKGROUND OF THE INVENTION

In the prior art JP6-233380A had supposed a loudspeaker with dual magnetic gap and dual coil which has disadvantages of bulk volume, low sensitivity while the inductance of dual coil cannot be cancelled and the loudspeaker remains a non-linear element with undesirable fidelity.

The main disadvantages of the loudspeaker with two voice coils and two magnetic field presented by CN94246701.9 are: relatively large volume, low sensitivity while the inductance of dual coil cannot be cancelled with short axial strokes of the coil not satisfied the requirement of loudspeaker with large power and high voice level. In the prior art the permanent magnet is fixed to the pole plate of adhesive which makes the magnetic path easy to be disconnected leading to damage of the loudspeaker due to strong heating by vortex in the case of continuously inputting signal of big power.

U.S. Pat. No. 5,748,760 disclosed a transducer driver with dual magnetic gap and dual coil formed by two annular pole plates and a neodymium magnet which has the disadvantages that the depth-to-width ratio should not greater than 0.2˜0.3, thus the short axial stroke and low sensitivity for this patent case. When inputting with high-power woof signals, misplacement and displacement will happen to the coils originally corresponding to the magnetic gaps to cause serious infidelity of the displacement asynchronism.

Also use of adhesive to the permanent magnet and magnetic pole increased magnetic resistance of the magnetic path and the complexity of production.

### SUMMARY

The object of the invention is to provide an transducer with dual magnetic gap and dual coil which eliminates the disadvantages of the prior art, has the resistance load characteristic, high fidelity, high sensitivity, small volume, good ventilation, and may have long and extreme long strokes without adhesive between the permanent magnet and the pole plate.

The object of the invention is achieved as follows:

A transducer with dual coil and dual magnetic gap comprising a magnetic path of permanent magnet and a frame integral with it, two coaxial annular magnetic gaps of the same diameters and a coil bobbin inserted in the magnetic gaps on which the insulated wiring is paralleled wound to form dual coil, a diaphragm connected with a damper and a coil bobbin is conical-shaped or spherical-shaped or a flat panel acoustic radiator, the diaphragm is vibrated in the air to produce sound by piston motion of the coil bobbin, or variations of sound pressure are detected by the diaphragm and audio voltage signals are induced in coils, which is characterized in that:
upper and lower pole plates of said magnetic path are two coaxial and symmetric inwardly concave plates made of magnetic material on the outer central portion of which a boss face is provided with a shaft hole which usually is a round hole, but can also be a square or hexagonal hole;
convex peripheral pole shoes are formed on the inner peripheries of said upper and lower pole plates, and a piece or more of the permanent magnets uniformly spaced with equal thickness and axial magnetization is provided between the pole faces of two peripheral pole shoes;
a hollow frame of non-magnetic material is embedded and bound to the inner face of the concave plates of said upper and lower pole plates with the inner vertical face of the permanent magnet mounted and bounded to the inner vertical face of the hollow frame and adhesive securing;
two pole faces of said permanent magnet are engaged with two pole faces of the peripheral pole shoes of the upper and lower pole plates, and a outer core of an integral magnetic path is formed by means of through holes formed on said boss faces of the upper and lower pole plates and non-magnetic fasteners, or by means of the static pressure by the upper and lower pole plates and adhesive applied to the engaging pole faces during the course of assembling;
two coaxial annular magnetic gaps of the same diameter are formed between the outer periphery of the annular or cylindrical magnetic body coaxial with the central hole of the inner concave plates of the upper and lower pole plates and the vertical periphery of the central holes of the upper and lower pole plates;
said coils and the central hole of said round plate are matched with said annular or cylindrical magnetic body, with its optimum section being regular hexagon and a short symmetric are provided on the top of inner corners of the regular hexagon or square while the arc is tangential to both sides of the inner corner and its center is located on the dividing line of the inner corner;
a frame made of non-magnetic materials coaxial with said magnetic path is formed to provide a base structure for said upper pole plate, permanent magnet, lower pole plate, and cylindrical magnetic body so that they are integrated as a whole part;
said two coaxial coils are inserted into said annular magnetic gaps, while wound direction of the dual coil and the direction of current produce an electrodynamic force F in the coils in the same moment and same direction;
with the dividing bisectrix x-x of half the axial highness of said permanent magnet as the horizontal symmetric axis said transducer with dual coil and dual magnetic gap has the symmetric magnetic path in geometry and magnetic characteristics, also the dual coil have opposite wound directions after connecting in series while the section area of the wiring of the dual coil, their turns and absolute value of the inductance are equal to each other with said transducer being a mechanic-electrical transducer with resistance load characteristics.

The said upper and lower pole plates are two round inner concave plates, and said permanent magnet is an annular permanent magnet or more than a piece of uniformly spaced sectorial or circular or annular rare metal permanent magnet.

The said upper and lower pole plates are two square inner concave plates and the permanent magnet is 4 pieces of uniformly spaced strip-like rare-metal permanent magnet with the same thickness.

More than two uniformly spaced inner concave convection holes are provided on the periphery pole shoes of the upper and lower pole plates with the deepest bottom leveled with the inner face of the said inner concave plate.

A frame of non-magnetic material is coaxially connected with said magnetic path with a coaxial open cylinder provided on the waist of the frame;
a coaxial annular concave groove is formed on the inner face of the bottom of said cylinder with two coaxial annular boss faces provided on the inner and outer sides of said annular groove;
an inner convex cylinder of non-magnetic material is provided on the axial position of the middle annular boss face to fix the annular magnetic body on said cylinder;
a non-magnetic annular connecting plate closes the vertical faces of the upper and lower pole plates, to embed the integral core of said magnetic path to the inner fitting face of the frame cylinder forming a integral unit with the frame.

The said frame is made of aluminum alloy or engineering plastics.

The upper and lower pole plates and the vertical outer periphery of the permanent magnet are closed by two or more than two collars of driver made of non-magnetic material;
the inner face of the collar and the pole plates as well as the vertical outer face of the permanent magnet are engaged with each other and bound together as a whole part;
a bracket of non-magnetic material is coaxially connected with said magnetic path, with a an inner convex boss face in the central portion, in which an central axial hole may be formed;
an coaxial annular concave groove is formed on the outer side of the said inner convex boss face, and a coaxial mounting face of the bracket engaged with the outer face of the lower pole plate and a collar of driver or outer face of the lower end of said annular magnetic body is provided on the outer side of the said annular concave groove;
a coaxial annular or cylindrical magnetic body is mounted on the axial position of the said boss face by a set of non-magnetic fasteners, or said upper and lower pole plates and said permanent magnet are mounted on the axial position of the said boss face by fasteners made of non-magnetic materials or adhesive;
two coaxial annular magnetic gaps of the same diameters are formed between the outer periphery of the annular cylindrical magnetic body and the vertical periphery of the central hole of the upper and lower pole plates, thus forming a complete magnetic path of the driver of the transducer with dual coil and dual magnetic gap.

The said collar of driver and said bracket is made of aluminum alloy or engineering plastics.

A transducer with dual coil and dual magnetic gap comprising a magnetic path of permanent magnet and a frame integral with it, two coaxial annular magnetic gaps of the same diameters and a coil bobbin inserted in the magnetic gap on which the insulated wiring is paralleled wound to form dual coil, a diaphragm connected with a damper and a coil bobbin is conical-shaped or spherical-shaped or a flat panel acoustic radiator, the diaphragm is vibrated in the air to produce sound by piston motion of the coil bobbin, or variations of sound pressure are detected by the diaphragm and audio voltage signals are induced in coils, which is characterized in that:
upper and lower pole plates of said magnetic path are two coaxial and symmetric inwardly concave plates made of magnetic material on the outer central portion of which a boss face is provided with a shaft hole which usually is a round hole, or can be a square or hexagonal hole;
convex peripheral pole shoes are formed on the inner peripheries of said upper and lower pole plates, and a piece or more of the permanent magnets uniformly spaced with equal thickness and axial magnetization is provided between the pole faces of two peripheral pole shoes;
a hollow frame of non-magnetic material is embedded and bound to the inner face of the concave plates of said upper and lower pole plates with the inner vertical face of the permanent magnet mounted and bounded to the inner vertical face of the hollow frame and adhesive securing;
two pole faces of said permanent magnet are engaged with two pole faces of the peripheral pole shoes of the upper and lower pole plates, and a outer core of an integral magnetic path is formed by means of through holes formed on said boss faces of the upper and lower pole plates and non-magnetic fasteners, or by means of the static pressure by the upper and lower pole plates and adhesive applied to the engaging pole faces during the course of assembling;
two coaxial annular magnetic gaps of the same diameter are formed between the outer periphery of the annular or cylindrical magnetic body coaxial with the central hole of the inner concave plates of the upper and lower pole plates and the vertical periphery of the central holes of the upper and lower pole plates;
said coils and the central hole of said round plate are matched with said annular or cylindrical magnetic body, with its optimum section being regular hexagon and a short symmetric are provided on the top of inner corners of the regular hexagon or square while the arc is tangential to both sides of the inner corner and its center is located on the dividing line of the inner corner;
a frame made of non-magnetic materials coaxial with said magnetic path is formed to provide a base structure for said upper pole plate, permanent magnet, lower pole plate, and cylindrical magnetic body so that they are integrated as a whole part;
said two coaxial coils are inserted into said annular magnetic gap, while wound direction of the dual coil and the direction of current produce an electrodynamic force F in the coils in the same moment and same direction.

The said upper and lower pole plates are two round inner concave plates, and said permanent magnet is an annular permanent magnet or more than a piece of uniformly spaced sectorial or circular or annular rare metal permanent magnet.

The said upper and lower pole plates are two square inner concave plates and the permanent magnet is 4 pieces of uniformly spaced strip-like rare-metal permanent magnet with the same thickness.

More than two uniformly spaced inner concave convection holes are provided on the periphery pole shoes of the upper and lower pole plates with the deepest bottom leveled with the inner face of the said inner concave plate.

A frame of non-magnetic material is coaxially connected with said magnetic path with a coaxial open cylinder provided on the waist of the frame;
a coaxial annular concave groove is formed on the inner face of the bottom of said cylinder with two coaxial annular boss faces provided on the inner and outer sides of said annular groove;
an inner convex cylinder of non-magnetic material is provided on the axial position of the middle annular boss face to fix the annular magnetic body on said cylinder;
a non-magnetic annular connecting plate closes the vertical faces of the upper and lower pole plates, to embed the integral core of said magnetic path to the inner fitting face of the frame cylinder forming a integral unit with the frame.

The said frame is made of aluminum alloy or engineering plastics.

The upper and lower pole plates and the vertical outer periphery of the permanent magnet are closed by two or more than two collars of driver made of non-magnetic material;
the inner face of the collar and the pole plates as well as the vertical outer face of the permanent magnet are engaged with each other and bound together as a whole part;
a bracket of non-magnetic material is coaxially connected with said magnetic path, with a an inner convex boss face in the central portion, in which an central axial hole may be formed;
an coaxial annular concave groove is formed on the outer side of the said inner convex boss face, and a coaxial mounting face of the bracket engaged with the outer face of the lower pole plate and a collar of driver or outer face of the lower end of said annular magnetic body is provided on the outer side of the said annular concave groove;
a coaxial annular or cylindrical magnetic body is mounted on the axial position of the said boss face by a set of non-magnetic fasteners, or said upper and lower pole plates and said permanent magnet are mounted on the axial position of the said boss face by fasteners made of non-magnetic materials or adhesive;
two coaxial annular magnetic gaps of the same diameters are formed between the outer periphery of the annular cylindrical magnetic body and the vertical periphery of the central hole of the upper and lower pole plates, thus forming a complete magnetic path of the driver of the transducer with dual coil and dual magnetic gap.

The said collar of driver and said bracket is made of aluminum alloy or engineering plastics.

A transducer with dual coil and dual magnetic gap comprising a magnetic path of permanent magnet and a frame integral with it, two coaxial annular magnetic gaps of the same diameters and a coil bobbin inserted in the magnetic gaps on which the insulated wiring is paralleled wound to form dual coil, a diaphragm connected with a damper and a coil bobbin is conical-shaped or spherical-shaped or a flat panel acoustic radiator, the diaphragm is vibrated in the air to produce sound by piston motion of the coil bobbin, or variations of sound pressure are detected by the diaphragm and audio voltage signals are induced in coils, which is characterized in that:
upper and lower pole plates of said magnetic path are two coaxial and symmetric round plates made of magnetic material;
said round plates can be provided with a shaft hole which usually is a round hole, but can also be a square or hexagonal hole;
one piece or more of the permanent magnets uniformly spaced with equal thickness and axial magnetization is provided between said upper pole plate and lower pole plate;
two coaxial annular magnetic gap of the same diameter are formed between the periphery of the annular or cylindrical magnetic body coaxial with the central axis of the upper and lower pole plates and the vertical periphery of the central holes of the upper and lower pole plates;
said coils and the central hole of said round plate are matched with said annular or cylindrical magnetic body, with its optimum section being regular hexagon and a short symmetric are provided on the top of inner corners of the regular hexagon or square while the arc is tangential to both sides of the inner corner and its center is located on the dividing line of the inner corner;
a frame made of non-magnetic materials coaxial with said magnetic path is formed to provide a base structure for said upper pole plate, permanent magnet, lower pole plate, and cylindrical magnetic body so that they are integrated as a whole part;
said two coaxial coils are inserted into said annular magnetic gap and arranged at certain intervals, while wound direction of the dual coil and the direction of current produce an electrodynamic force F in the coils in the same moment and same direction;
with the dividing bisectrix x-x of half the axial highness of said permanent magnet as the horizontal symmetric axis said transducer with dual coil and dual magnetic gap has the symmetric magnetic path in geometry and magnetic characteristics, also the dual coil have opposite wound directions after connecting in series while the section area of the wiring of the dual coil, their turns and absolute value of the inductance are equal to each other with said transducer being a mechanic-electrical transducer with resistance load characteristics.

The said annular or cylindrical magnetic body are enclosed by said permanent magnet;
a shaft hole is formed on the central portion of each of said upper and lower pole plates, three or more sets of uniformly spaced permanent magnets of the same thickness are provided on the outer periphery of the central hole of the said upper and lower pole plates, each set of which is formed by 2 annular permanent magnets laminated in series and magnetized axially;
four pole faces of each set of permanent magnets are directly engaged with two pole faces of the upper and lower pole plates;
a outer core of an integral magnetic path is formed by means of through holes formed on the axial position of said annular permanent magnets of the upper and lower pole plates and non-magnetic fasteners, or by means of the static pressure by the upper and lower pole plates and adhesive applied to the engaging pole faces during the course of assembling.

The said upper and lower pole plates are inwardly concave plates with a shaft hole formed on the central portion of each of the said upper and lower pole plates;
convex peripheral pole shoes are formed on the inner peripheries of said upper and lower pole plates, and a piece of annular permanent magnet or more pieces of sectorial or circular or annular rare metal permanent magnets uniformly spaced with equal thickness and axial magnetization are provided between the pole faces of two peripheral pole shoes;
two pole faces of said permanent magnet are engaged with two pole faces of the upper and lower pole plates;
and a outer core of an integral magnetic path is formed by means of through holes formed on said upper and lower pole plates and non-magnetic fasteners, or by means of the static pressure by the upper and lower pole plates and adhesive applied to the engaging pole faces during the course of assembling.

The said annular or cylindrical magnetic body are enclosed by said permanent magnet;
a shaft hole is formed on the central portion of each of said upper and lower pole plates, a piece of annular permanent magnet or more pieces of sectorial or circular or annular rare metal permanent magnets uniformly spaced with equal thickness and axial magnetization are provided on the outer periphery of the central hole of the said upper and lower pole plates;
two pole faces of said permanent magnet are engaged with two pole faces of the upper and lower pole plates;
a outer core of an integral magnetic path is formed by means of through holes formed on the upper and lower pole plates and non-magnetic fasteners, or by means of the static pressure by the upper and lower pole plates and adhesive applied to the engaging pole faces during the course of assembling.

The said permanent magnet are enclosed by said annular magnetic body;
said upper and lower pole plates are two round plates without shaft holes;
a piece of annular permanent magnet or more pieces of sectorial or circular or annular rare metal permanent magnets uniformly spaced with equal thickness and axial magnetization are provided between the upper and lower pole plates;
two pole faces of said permanent magnet are engaged with two pole faces of the upper and lower pole plates;
a inner core of an integral magnetic path is formed by means of through holes formed on said upper and lower pole plates and non-magnetic fasteners, or by means of the static pressure by the upper and lower pole plates and adhesive applied to the engaging pole faces during the course of assembling.

The said permanent magnet are enclosed by said annular magnetic body;
said upper and lower pole plates are two round plates shaft holes formed on the central portion of each of said upper and lower pole plates;
a piece of annular ferrite or rare metal permanent magnets between the upper and lower pole plates;
two pole faces of said permanent magnet are engaged with two pole faces of the upper and lower pole plates;
a inner core of an integral magnetic path is formed by means of through holes formed on said upper and lower pole plates and non-magnetic fasteners, or by means of the static pressure by the upper and lower pole plates and adhesive applied to the engaging pole faces during the course of assembling.

A frame of non-magnetic material is coaxially connected with said magnetic path with a coaxial open cylinder provided on the waist of the frame;
a coaxial annular concave groove is formed on the inner face of the bottom of said cylinder with two coaxial annular boss faces provided on the inner and outer sides of said annular groove;
an inner convex cylinder of non-magnetic material is provided on the axial position of the middle annular boss face to fix the annular magnetic body on said cylinder;
a non-magnetic annular connecting plate closes the vertical faces of the upper and lower pole plates, to embed the integral core of said magnetic path to the inner fitting face of the frame cylinder forming a integral unit with the frame.

The said frame is made of aluminum alloy or engineering plastics.

The upper and lower pole plates and the vertical outer periphery of the permanent magnet are closed by two or more than two collars of driver made of non-magnetic material;
the inner face of the collar and the pole plates as well as the vertical outer face of the permanent magnet are engaged with each other and bound together as a whole part;
a bracket of non-magnetic material is coaxially connected with said magnetic path, with a an inner convex boss face in the central portion, in which an central axial hole may be formed;
an coaxial annular concave groove is formed on the outer side of the said inner convex boss face, and a coaxial mounting face of the bracket engaged with the outer face of the lower pole plate and a collar of driver or outer face of the lower end of said annular magnetic body is provided on the outer side of the said annular concave groove;
a coaxial annular or cylindrical magnetic body is mounted on the axial position of the said boss face by a set of non-magnetic fasteners, or said upper and lower pole plates and said permanent magnet are mounted on the axial position of the said boss face by fasteners made of non-magnetic materials or adhesive;
two coaxial annular magnetic gaps of the same diameters are formed between the outer periphery of the annular cylindrical magnetic body and the vertical periphery of the central hole of the upper and lower pole plates, thus forming a complete magnetic path of the driver of the transducer with dual coil and dual magnetic gap.

The said collar of driver and said bracket is made of aluminum alloy or engineering plastics.

A transducer with dual coil and dual magnetic gap comprising a magnetic path of permanent magnet and a frame integral with it, two coaxial annular magnetic gaps of the same diameters and a coil bobbin inserted in the magnetic gap on which the insulated wiring is paralleled wound to form dual coil, a diaphragm connected with a damper and a coil bobbin is conical-shaped or spherical-shaped or a flat panel acoustic radiator, the diaphragm is vibrated in the air to produce sound by piston motion of the coil bobbin, or variations of sound pressure are detected by the diaphragm and audio voltage signals are induced in coils, which is characterized in that: upper and lower pole plates of said magnetic path are two coaxial and symmetric round plates made of magnetic material;
said round plates can be provided with a shaft hole which usually is a round hole, but can also be a square or hexagonal hole;
one piece or more of the permanent magnets uniformly spaced with equal thickness and axial magnetization is provided between said upper pole plate and lower pole plate;
two coaxial annular magnetic gaps of the same diameter are formed between the periphery of the annular or cylindrical magnetic body coaxial with the central axis of the upper and lower pole plates and the vertical periphery of the central holes of the upper and lower pole plates;
said coils and the central hole of said round plate are matched with said annular or cylindrical magnetic body, with its optimum section being regular hexagon and a short symmetric are provided on the top of inner corners of the regular hexagon or square while the arc is tangential to both sides of the inner corner and its center is located on the dividing line of the inner corner;
a frame made of non-magnetic materials coaxial with said magnetic path is formed to provide a base structure for said upper pole plate, permanent magnet, lower pole plate, and cylindrical magnetic body so that they are integrated as a whole part;
said two coaxial coils are inserted into said annular magnetic gap and arranged at certain intervals, while wound direction of the dual coil and the direction of current produce an electrodynamic force F in the coils in the same moment and same direction.

The said annular or cylindrical magnetic body are enclosed by said permanent magnet;
a shaft hole is formed on the central portion of each of said upper and lower pole plates, three or more sets of uniformly spaced permanent magnets of the same thickness are provided on the outer periphery of the central hole of the said upper and lower pole plates, each set of which is formed by 2 annular permanent magnets laminated in series and magnetized axially;
four pole faces of each set of permanent magnets are directly engaged with two pole faces of the upper and lower pole plates;
a outer core of an integral magnetic path is formed by means of through holes formed on the axial position of said annular permanent magnets of the upper and lower pole plates and non-magnetic fasteners, or by means of the static pressure by the upper and lower pole plates and adhesive applied to the engaging pole faces during the course of assembling.

The said upper and lower pole plates are inwardly concave plates with a shaft hole formed on the central portion of each of the said upper and lower pole plates;
convex peripheral pole shoes are formed on the inner peripheries of said upper and lower pole plates, and a piece of annular permanent magnet or more pieces of sectorial or circular or annular rare metal permanent magnets uniformly spaced with equal thickness and axial magnetization are provided between the pole faces of two peripheral pole shoes;
two pole faces of said permanent magnet are engaged with two pole faces of the upper and lower pole plates;
and a outer core of an integral magnetic path is formed by means of through holes formed on said upper and lower pole plates and non-magnetic fasteners, or by means of the static pressure by the upper and lower pole plates and adhesive applied to the engaging pole faces during the course of assembling.

The said annular or cylindrical magnetic body are enclosed by said permanent magnet;
a shaft hole is formed on the central portion of each of said upper and lower pole plates, a piece of annular permanent magnet or more pieces of sectorial or circular or annular rare metal permanent magnets uniformly spaced with equal thickness and axial magnetization are provided on the outer periphery of the central hole of the said upper and lower pole plates;
two pole faces of said permanent magnet are engaged with two pole faces of the upper and lower pole plates;
a outer core of an integral magnetic path is formed by means of through holes formed on the upper and lower pole plates and non-magnetic fasteners, or by means of the static pressure by the upper and lower pole plates and adhesive applied to the engaging pole faces during the course of assembling.

The said permanent magnet are enclosed by said annular magnetic body;
said upper and lower pole plates are two round plates without shaft holes;
a piece of annular permanent magnet or more pieces of sectorial or circular or annular rare metal permanent magnets uniformly spaced with equal thickness and axial magnetization are provided between the upper and lower pole plates;
two pole faces of said permanent magnet are engaged with two pole faces of the upper and lower pole plates;
a inner core of an integral magnetic path is formed by means of through holes formed on said upper and lower pole plates and non-magnetic fasteners, or by means of the static pressure by the upper and lower pole plates and adhesive applied to the engaging pole faces during the course of assembling.

The said permanent magnet are enclosed by said annular magnetic body;
said upper and lower pole plates are two round plates shaft holes formed on the central portion of each of said upper and lower pole plates;
a piece of annular ferrite or rare metal permanent magnets between the upper and lower pole plates;
two pole faces of said permanent magnet are engaged with two pole faces of the upper and lower pole plates;
a inner core of an integral magnetic path is formed by means of through holes formed on said upper and lower pole plates and non-magnetic fasteners, or by means of the static pressure by the upper and lower pole plates and adhesive applied to the engaging pole faces during the course of assembling.

A frame of non-magnetic material is coaxially connected with said magnetic path with a coaxial open cylinder provided on the waist of the frame;
a coaxial annular concave groove is formed on the inner face of the bottom of said cylinder with two coaxial annular boss faces provided on the inner and outer sides of said annular groove;
an inner convex cylinder of non-magnetic material is provided on the axial position of the middle annular boss face to fix the annular magnetic body on said cylinder;
a non-magnetic annular connecting plate closes the vertical faces of the upper and lower pole plates, to embed the integral core of said magnetic path to the inner fitting face of the frame cylinder forming a integral unit with the frame.

The said frame is made of aluminum alloy or engineering plastics.

The upper and lower pole plates and the vertical outer periphery of the permanent magnet are closed by two or more than two collars of driver made of non-magnetic material;
the inner face of the collar and the pole plates as well as the vertical outer face of the permanent magnet are engaged with each other and bound together as a whole part;
a bracket of non-magnetic material is coaxially connected with said magnetic path, with a an inner convex boss face in the central portion, in which an central axial hole may be formed;
an coaxial annular concave groove is formed on the outer side of the said inner convex boss face, and a coaxial mounting face of the bracket engaged with the outer face of the lower pole plate and a collar of driver or outer face of the lower end of said annular magnetic body is provided on the outer side of the said annular concave groove;
a coaxial annular or cylindrical magnetic body is mounted on the axial position of the said boss face by a set of non-magnetic fasteners, or said upper and lower pole plates and said permanent magnet are mounted on the axial position of the said boss face by fasteners made of non-magnetic materials or adhesive;
two coaxial annular magnetic gaps of the same diameters are formed between the outer periphery of the annular cylindrical magnetic body and the vertical periphery of the central hole of the upper and lower pole plates, thus forming a complete magnetic path of the driver of the transducer with dual coil and dual magnetic gap.

The said collar of driver and said bracket is made of aluminum alloy or engineering plastics.

The details of one or more embodiments of the invention are set forth in the accompanying description below. Other advantages, features, and objects of the invention will be apparent from the detailed description and the claims.

### BRIEF DESCRIPTION OF THE DRAWINGS

FIG. 1 is the longitudinal section view of the driver of the transducer according to the embodiment 1 of present invention.

FIG. 2 is the longitudinal section view of the loudspeaker according to the embodiment 2 of the invention.

FIG. 3 is the plan section view of the magnetic path A-A according to embodiment 2 of the invention.

FIG. 4 is the plan section view of the magnetic path A-A according to embodiment 3 of the invention.

FIG. 5 is the plan section view of the magnetic path A-A according to embodiment 4 of the invention.

FIG. 6 is the plan section view of the magnetic path A-A according to embodiment 5 of the invention.

FIG. 7 is the plan and longitudinal section view of the magnetic path A-A according to embodiment 6 of the invention.

FIG. 8 is the longitudinal section view of the loudspeaker according to embodiment 7 of the invention.

FIG. 9 is the plan section view of the magnetic path A-A according to embodiment 7 of the invention.

FIG. 10 is the principle-wiring scheme of the circuit of the transducer with resistance load characteristic.

FIG. 11 is the plan view of the bracket of the embodiment 1 of the invention.

FIG. 12 is the plan and perspective view of the driver with a collar according to embodiment 1 of the invention.

FIG. 13 is the plane and perspective view of the driver with a collar according to embodiment 2 of the invention.

FIG. 14 is the plan view of an embodiment of the hollow frame of the invention.

FIG. 15 is the plan view of another embodiment of the hollow frame of the invention.

FIG. 16 is the schematic plan view of an embodiment of a hexagonal magnetic gap of the invention.

FIG. 17 is the schematic plan view of an embodiment of a hexagonal magnetic gap and the arc section of the internal corner of the hexagonal annular magnetic body of the invention.

FIG. 18 is the schematic plan and perspective view of an embodiment of the cylindrical body of the invention.

FIG. 19 is the longitudinal plan of the magnetic path according to embodiment 8 of the invention.

FIG. 20 is the longitudinal plan of the magnetic path and the bracket according to embodiment 9 of the invention.

FIG. 21 is the longitudinal plan of the magnetic path according to embodiment 10 of the invention.

### SYMBOLS OF THE DRAWINGS

Pole surface—100,200,300,400,500,600,700,800,900,1100
Frame—101,201,301,401,501,601,701,801,901,1101
Threaded hole for assembling of the frame—1061,2061,3061,4061,5061,6061,8061,9061,11061
Recess fitting face—133,233,333,433,533,633,733,833,933, 1133
Annular concave groove—135,235, 335, 435, 535,635,735,835,935, 1135
Permanent magnet—102,202, 302, 402, 502,602,702,802,902, 1102
Upper pole plate (lower pole plate)—103,203, 303, 403, 503,603,703,803,903, 1103
Periphery pole shoe of the pole plate—129,229, 329, 429, 529,629,729,829, 929, 1129
Convection ventilation hole—117,217,317, 417, 517,717,917, 1117
Outer boss face of the upper (lower) pole plate—10300,20300, 30300, 40300,50300, 60300, 70300,80300,9030,110300
Inner profile face of the upper (lower) pole plate—124,224,324, 424, 524,624,724,824, 924, 1124
Through hole of the upper pole plate—1061,2061,3061,4061, 5061,6061,7061,8061,9061,
Threaded hole of the lower pole plate—1071,2071,3071, 4071, 5071,6071,7071,8071,9071, 1171
Inner convex lip edge—1030,2030, 3030, 4030, 5030,6030,7030,8030,9030, 1130
Annular connecting plate—136,236,536,636,736,836
Structure space—163,263,563,663,763,863,963,1163
Hollow frame—104,204,504,604,604,704,804
Outer profile face of the hollow frame—134,234,534,634,734,834
Inner profile face of the hollow frame—173, 273,573,673,773,873
Outer vertical face of the hollow frame—123,222,522,622,722,822,922
Diaphragm—106,206,306, 406, 506,606,706,806,906,1106
Elastic edge—199,299,399, 499,599,699,799,899,999, 1199
Damper—141,241,341,541,641, 741, 841, 941,1141
Coil bobbin—107,207, 307, 407,507,607,707,807,907,1107
Coil—109,209,309,409 509,609,709,809,909,1109
Annular support face—108,208,508,608,708,808,908,1108
Annular support face—142,242,342, 442,542,642,742,842,942, 1142
Annular concave groove—1630,2630,3030, 4030, 5030, 6630,7630, 8630,9630, 11630
Annular magnetic gap—110,210,310, 410,510,610,710,810,910, 1110
Inner convex boss face—111,211,311,411, 511,611,711,811,911, 1111
Inner convex cylindrical body—112,212,312, 412, 512,612,712,812,912, 1112
Annular magnetic body—113,213,313, 413, 513,613,713,813,913, 1113
Central shaft hole—114,214,314, 414, 514,614,714,814,914, 1114
Washer of the annular magnetic body—184,284, 384, 484, 584,684,784,884,984, 1184
Bracket—181,281,381, 481, 581,681,781,881,981,1181
Air holes of the bracket—182, 281, 382, 482, 582, 682, 782, 982, 1182
Through hole of the bracket—187,287,387, 487, 587,687,787,887,987, 1187
Outer inwardly concave face of the bracket—1811,2811,3811, 4811, 5811,6811, 7811, 8811,9811,11811
Inwardly convex boss face of the bracket—1118,2118,3118, 4118,5118,6118,7118,8118,9118,1118
Bracket's mounting surface—1800,2800,3800,4800,5800,6800,7800,8800,9800,11800
Threaded hole of the bracket—188,288,388, 488, 588,688,788,888,988,1188
Nut—183,283,383, 483,583,683,783,883,983, 983,1183
Collar of the driver—137,237,337, 437,537,637,737,837,937,1137
Inner concave groove of the collar—139,239,539,639,739,839,1139
Inner profile face of the collar—138,238,338, 438,538,638,738,838, 1138
Ventilation hole of the collar—140,240,340,540,640,740,840, 1140
Non-magnetic fastener—1000,2000,3000,4000,8000,5000,6000,7000,9000, 11000
Non-magnetic bolt—180,280,380,480,580,680,780,880,980,1180
Dust cap—105,205,305,405,505,605,705,805,905,1105
Adhesive—001

### DETAILED DESCRIPTION

Hereafter, the embodiments of the invention will be described according to the drawings.

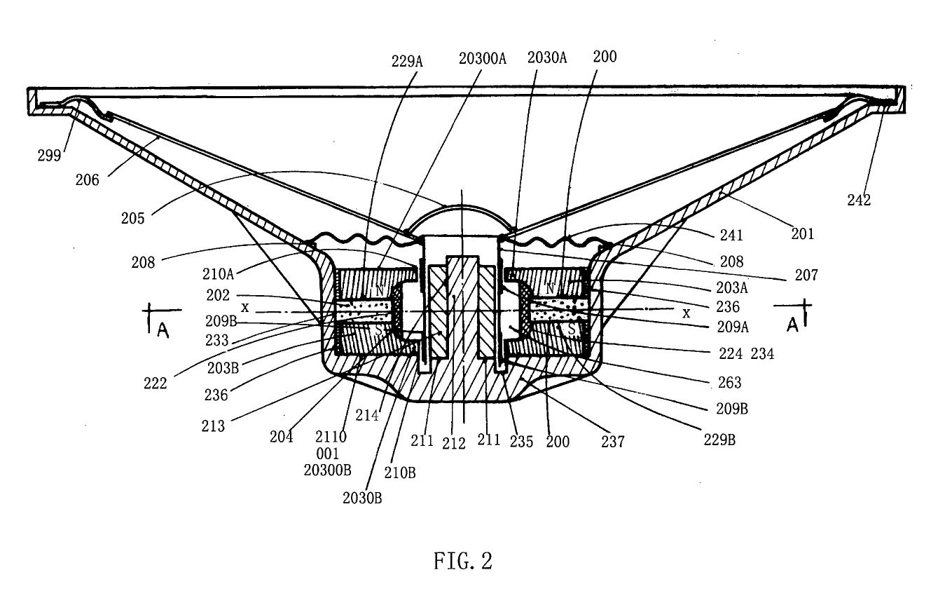

FIG. 2 shows the longitudinal section view of the loudspeaker according to embodiment 2 of the invention.

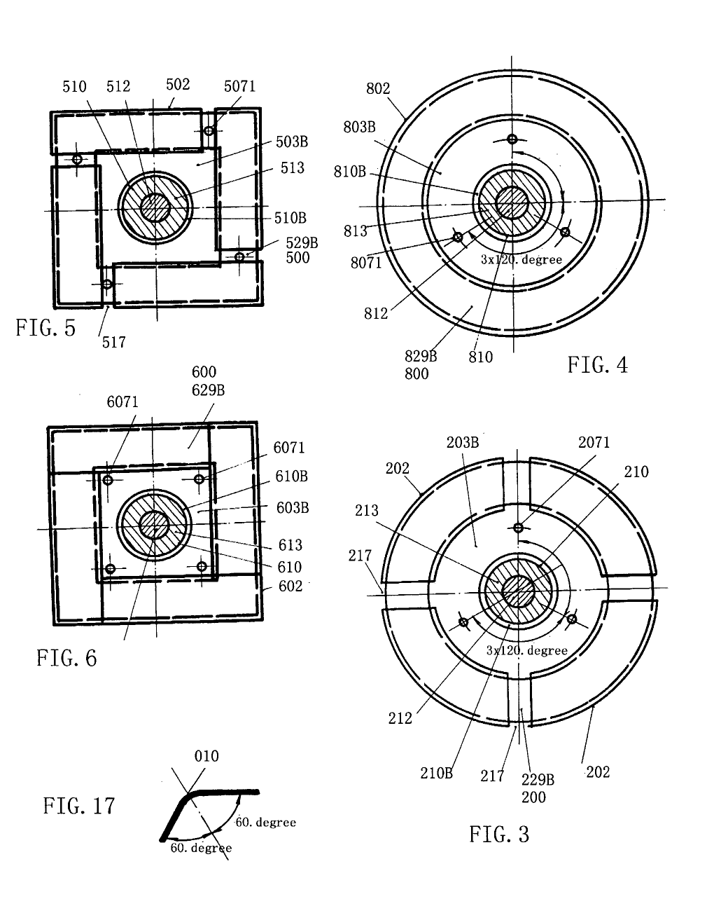

The upper pole plate 203A and the lower pole plate 203B are two circular inwardly concave plates with equal projected planes and symmetrically disposed. A boss face 20300 with a central shaft hole 210 in the central portion is provided at the outer side of each concave plate. The convex periphery pole shoes 229A and 229B are disposed on the inner periphery of the upper pole plate 203A and lower pole plate 203B. The hollow frame 204 of non-magnetic material is embedded between the upper pole plate 203A and the inner profile face 224 of the lower pole plate 203B. The outer profile face 234 of the hollow frame 204 and the inner profile face 224 of the upper and lower pole plates are engaged with each other and applied with adhesive 001. The outer vertical face 222 with adhesive 001 applied there to in advance is provided in the middle of the outer profile of the hollow frame 204. The inner vertical face of the permanent magnet 201 is positioned by the outer vertical face 222 of the hollow frame. Between pole faces 200 of the periphery pole shoes 229A and 229B of the upper. Lower pole plates 4 uniformly spaced sectorial rare-metal permanent magnets 202(e.g. neodymium magnet) with the same thickness, areas, volume and magnetic properties are arranged with their pole faces 200 directly engaged with the pole faces of the periphery pole shoes. Three or more uniformly spaced through holes 2061(not shown in FIG. 2, and may be referred to the threaded hole 2071 in FIG. 3) are provided along the outer side of the shaft hole on the plate between the central shaft hole 210A of the upper pole plate and the boss face 20300A. And three or more uniformly spared threaded holes 2071 corresponding to the through hole 2061 (not shown in FIG. 2, may be referred to FIG. 3) are provided on the plate between the central shaft hole 210B of the lower pole plate 203B and the boss face 20300B. Some static pressure is applied to the engaged pole faces 200 of the upper pole plate 203A, lower pole plate 203B and permanent magnet 202 via 3 or more matching non-magnetic fasteners (e.g. copper screw). After curing of the adhesive 001, an integral magnetic path of the loudspeaker with small magnetic resistance is obtained without adhesive applied between the permanent magnet and the engaged pole faces of the upper and lower pole plates. For facilitating the assembly work the annular connecting plates 236 made of non-magnetic material with the outer diameter equal to that of the permanent magnet 202 are bound to the outer vertical faces of the upper pole plate 203A and lower pole plate 203B (sometimes it is possible to provide one annular connecting plate on the upper, lower pole plates and the outer vertical faces of the permanent magnet, then fix then with adhesive 001). Therefore, an outer core of the magnetic path of the loudspeaker is formed.

In order to exert the merit of the high magnetic energy product of the neodymium magnet, the thin pieces of the neodymium magnet are saturated in advance in the embodiment, and then embodied between the periphery pole shoes of the upper pole plate 203A and lower pole plate 203B. The detail description of which can be found in the patent application WO 98/47312 of the inventor. (It is no doubt that the permanent magnet may be magnetized after an integral magnetic path is formed by binding the upper pole plate 203A, lower pole plate 203B, permanent magnet 202, hollow frame 204 and the annular connecting plate 236).

The loudspeaker is provided with frame 201 made of non-magnetic rigid material (for example aluminum alloy), which is shaped, cylindrical below its waist. An inwardly convex boss 211 is provided on the axial bottom of the cylinder which is an annular horizontal surface symmetric with respect to the central axis of the shaft hole 210. In the upper middle portion of the cylinder a concave matching face 233 is formed which is coaxial and perpendicularly intersected with the inwardly convex boss face 211. A coaxial annular concave groove 235 is formed on the outer side of the inwardly convex boss face 211, which provides the coil bobbin 207 of the loudspeaker with sufficient space to move down. An annular boss face 2110 is also provided on the outer side of the annular concave groove 235 which is also coaxial and perpendicularly intersected with the concave matching face 233.

After the outer core of the magnetic path of the driver comprised of the upper pole plate 203A, lower pole plate 203B, permanent magnet 202, hollow frame 204 and the annular connecting plate 236 has embedded from the outside of the frame 201 in the concave matching face 233 cylindrically shaped in the middle of the frame, an annular magnetic body 213 formed of magnetic material is embedded in the inwardly convex cylindrical body 212 disposed in the axial portion of the inwardly convex boss face 211, and than is bound to the convex boss face 211. The inwardly convex cylindrical body 212 of the non-magnetic material may be integrally formed while casting the frame 201 of aluminum alloy, or may be fixed to the bottom of the frame cylinder by means of non-magnetic fasteners. It can be seen from FIG. 13 that the diameters of the central shaft holes of the upper pole plate 203A and the lower pole plate 203B are less than the diameter of the projected plane of the 4 uniformly spaced sectorial permanent magnets 202. Therefore uniform inner lip edges 2030A and 2030B are protruded along the radial inner side from the coaxial inner concave plate, between the inner vertical periphery of which and the outer periphery of the coaxial annular magnetic body 213 two annular magnetic gaps 210A and 210B with equal diameters are formed. Two independent coils 209A and 209B are wound on the cylindrical coil bobbin 207 with the upper end of which bound with the diaphragm of the loudspeaker 200, and the damper 241. The elastic rim 299 of the membrane 206 and the other end of the damping plate 241 are bound to the annular support faces 242 and 208 provided by the frame 201 respectively. The polarity after magnetization of the permanent magnet 202 is shown in FIG. 2. By way of example of the left magnetic path from the central line of the loudspeaker in FIG. 2, the closed magnetic path is formed by the magnetic lines of the permanent magnet through N pole of 202→203A→210A→209A→210→213→210B→209B→210B→203B—S pole of 202. Compared with the annular plate and T-shaped iron magnetic path of the traditional loudspeaker the invention eliminates the T-shaped iron for switching the direction of the magnetic lines by 90 degree, thus the equivalent inductance and the-flux leakage of the magnetic path are significantly reduced, and the electric-voice transducer efficiency is greatly increased.

Referring to the left side of the magnetic path it can be seen, that the magnetic lines of the upper magnetic gap 210A pass through the coil 209A from left to right, and the magnetic lines of the lower magnetic gap 210B pass through the coil 209A from the right. Directions of both magnetic lines have 180 degree phase changes. Therefore, if the dual coil 209A and 209B are wound in opposite directions, then at the same moment when both the coils are connected to an audio current, the electrodynamic forces FA and FB of both coils have the same directions, thus the electrodynamic force of the loudspeaker's coil F=FA+FB. In the case of reversed phase of the audio current, the directions of FA and FB are reversed and the electrodynamic force of the loudspeaker F=FA+FB remains unchanged with its direction just opposite.

When the coils 209A and 209B are parallel connection in opposite directions, the equivalent inductance will reduced by half, leading to remarkable improvement of the response curve of the impedance VS frequency.

During the continuous operation of the loudspeaker under the large audio current, the upper pole plate 203A, lower pole plate 203B and the annular magnetic body 213 will expand due to vortex heating. However, owing to the adhesive positioning of the upper pole plate 203A, outer vertical face of the lower pole plate 203B, the annular connecting plate 236 and the frame 201, as well as the adhesive positioning of the inner vertical face of the permanent magnet 202 and the outer vertical face 222 of the hollow frame 204, the adhesive 001 on the positioning portions is only subjected to tension or compression stress in vertical direction, thus the adhesive 001 obtains its maximum strength. The horizontal displacement the upper and lower pole plates does not occur in this case, so is the case with the annular magnetic body.

The structure space formed by the upper and lower pole plates as well as the inner vertical face of the hollow frame 204 decreases the damping of the axial movement of the diaphragm of the loudspeaker, increasing the transient response velocity of the loudspeaker and improvement of the ventilation of the coils.

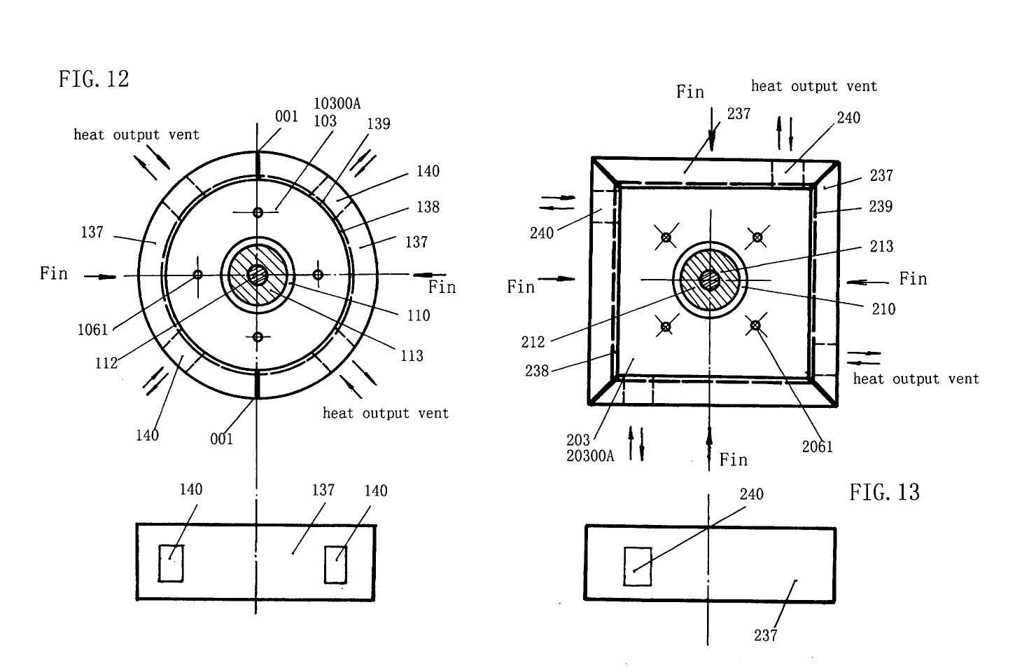

4 convection holes 217 are provided on the pole shoes at the intervals of adjacent two permanent magnets. The bottom of the holes are leveled with the inner bottom of the upper and lower pole plates as shown in FIG. 3 and FIG. 12.

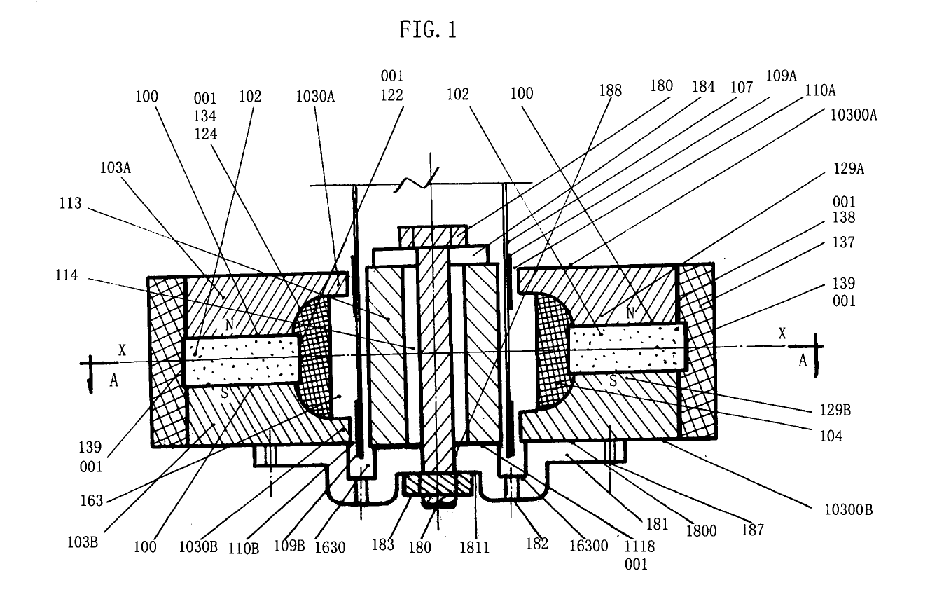

FIG. 1 shows the longitudinal section view of the transducer of the embodiment 1 of the invention. An integral magnetic path is formed by the upper pole plate 103A, lower pole plate 103B, permanent magnet 102, hollow frame 104 connected by means of adhesive 001 and the through hole 1061 of the upper pole plate, threaded hole 1071 of the lower pole plate and non-magnetic fasteners 1000, in the same manner as the embodiment 2 in FIG. 2. Thus its description is omitted.

Since the high value of the Br value of the rare-metal permanent magnet (such as neodymium-boron magnet) and its maximum magnetic energy product, therefore the gradient of the magnetic field of the leakage flux on the outer face of the transducer is high. It's a result of abstraction of the ferrous magnetic substance to the surface of the driver, the flux density within the annular magnetic gap of the driver is decreased. In addition, the rare-metal magnet such us neodymium-boron is easily damaged by mechanical impact due to its brittleness. In order to soft this problem the magnetic path is covered by two driver collar 137 of non-magnetic material along the upper pole plate 103A, lower pole plate 103B and the vertical outer face of the permanent magnet 102 in this embodiment. The collar 137 is pressure-cast with plastics. The concave groove 139 of the collar fitted with the outer vertical face of the permanent magnet 102 is provided on the inner face 138 of the collar 137. Adhesive 001 is applied in advance to the inner face 138 or the outer vertical face of the magnetic path, and simultaneously the static force Fin is applied to the collar 137 from outside as shown by the arrows in FIG. 12. Adhesive 001 a force Fin are also applied to the coupling face of each collar, so a mechanic-electrical transducer of high strength is obtained after curing of the adhesive. The same driver can also be formed using the through hole or threaded hole in the coupling porous of two collar 137 and fasteners made of non-magnetic material.

Difference with the embodiment 2 is as follows: the bracket 181 formed of non-magnetic pressure-cast aluminum alloy has a coaxial and symmetric annular mounting surface 1800 on which 4 uniformly spaced through holes 187 are arranged. With 4 bolts the bracket 181 is fixed to the axial position on the outer boss face 1030B of the lower pole plate. A shaft hole 188 is provided in the center of the bracket 181 with a coaxial inwardly convex boss face 1118 at the outer side. A coaxial annular concave groove 1630 is formed in the outer side of the boss face 1118. The annular is extending outwardly (downwardly) to form a space for the coil bobbin of the transducer to be moved downwardly. An washer 184 of the annular magnetic body made of non-magnetic material is mounted on the upper end of the annular magnetic body 113 with a non-magnetic bolt 180 passed through lower end of the magnetic body 113 to be fixed on the axial position of the boss-face 1118 of the bracket 181. Two coaxial annular magnetic gaps 110A and 110B with the same diameters are formed between periphery surface of the annular magnetic body 113 and the vertical face of the shaft hole of the upper pole plate 103A and lower pole plate 103B. A coil bobbin 107 with dual coil 109A and 109B wound in opposite directions is inserted into the two annular magnetic gaps to form the driver of the mechanic-electrical transducer using the bracket structure.

The frame of the diaphragm of the embodiment may be directly mounted on the outer boss face 10300A of the upper pole plate 103A by bolts, like the traditional conical frame of aluminum alloy. Also the diaphragm and the associated plate may be directly mounted on the outer boss face 10300A, like the traditional semi-spherical high volume diaphragm and its frame of the loudspeaker.

In order to reduce the damping of axial improvement of the transducer and improve the ventilation of the coils some uniformly spaced air holes 182 of the bracket are provided on the bottom 16300 of the annular concave groove of the bracket, as shown in FIG. 11.

The structure and principle are similar to that to embodiment 2 of FIG. 2, so the description is omitted.

FIG. 3 shows the plan section view of the magnetic path A-A of embodiment 2 of the invention.

The upper pole plate 203A and lower pole plate 203B of the loudspeaker are two coaxial and symmetric round concave plates. 4 pieces of sectorial thin pieces 202 of the neodymium magnet with the same magnetic characteristic, thickness, areas and volumes are embedded between the pole faces 200 of the periphery pole shoes 229A and 229B of the pole plates. Clearance and convection holes 217 on the sides are provided on the ends of each magnet. 4 corresponding convection air holes 27 with bottoms leveled with the inner face of the concave plate are formed on the periphery pole shoes 229A and 229B of the upper pole plate 203A and lower pole plate 203B. The hollow frame 204 is omitted in the fig.

The reminder portions are the same as that of embodiment 1 and 2, so they are not repeated here.

FIG. 4 shows the plan section view of the magnetic path A-A of the embodiment 3.

The upper pole plate 803A and lower pole plate 203B of the transducer are two coaxial and symmetric round concave plates. The permanent magnet 802 is an annular neodymium magnet embedded between the pole faces 800 of the periphery pole shoes 829A and 829B of the pole plates. Three uniformly spaced through holes 806 on the boss face 804 of the upper pole plate and three corresponding threaded holes 807 on the boss face 804 of the lower pole plate are for use of three non-magnetic fasteners to connect the magnetic path of the driver of the transducer. The hollow frame 804 is omitted in the fig.

The rest is similar to that of the embodiment 1, so it is not repeated here.

FIG. 5 shows the plan section view of the magnetic path A-A of the embodiment 4.

The upper pole plate 503A and lower pole plate 503B of the mechanic electrical transducer are two coaxial and symmetric square concave plates. 4 pieces of sectorial thin pieces 502 of the neodymium magnet with the same magnetic characteristic, thickness, areas and volumes are embedded between the pole faces 500 of the periphery pole shoes 529A and 529B of the pole plates. Clearance and convection holes 517 on the sides are provided on the ends of each magnet. 4 uniformly spaced through hoes 5061 and associated threaded holes 5071 are provided on the periphery pole shoes 529A and 529B of the pole plates for the 4 non-magnetic fasteners to connect the magnetic path of the driver of the transducer. The hollow frame 504 is not shown in the fig.

The remainder is similar to that of the embodiment 1 and 2, so it is not repeated here.

FIG. 6 shows the plan section view of the magnetic path A-A of embodiment 5.

The upper pole plate 603A and lower pole plate 603B of the mechanic electrical transducer are two coaxial and symmetric square concave plates. 4 pieces of sectorial thin pieces 602 of the neodymium magnet with the same magnetic characteristic, thickness, areas and volumes are embedded between the pole faces 600 of the periphery pole shoes 629A and 629B of the pole plates. 4 uniformly spaced through hoes 5061 and associated threaded holes 5071 are provided on the boss face of the upper pole plate 603A for the 4 non-magnetic fasteners to connect the magnetic path of the driver of the transducer. The hollow frame 504 is art shown in the fig.

FIG. 7 shows the longitudinal plan section view of the magnetic path A-A of embodiment 6.

Referring to FIG. 7-1 and FIG. 7-2, the upper pole plate 303A and the lower pole plate 303B of the transducer are two coaxial and symmetric inner concave plates with eight pieces of identical circular neodymium magnets 302 of same thickness, areas, volumes, as well as same magnetic performance uniformly arranged and bound to locations between pole faces 300 of said periphery pole shoes of the pole plate 329A and 329B with adhesive 001. Four through holes 3061 uniformly distributed on the flat face of the upper pole plate 303A corresponds to four through holes 3071 uniformly distributed on the flat face of the upper pole plate 303B. Four fasteners (not shown) of non-magnetic materials pass through the above through holes to further strengthen the magnetic path of the transducer driver. Gaps between two sets of adjacent round neodymium magnets provide sufficient convection ventilation hole. The present embodiment can provide enough long stroke or super long stroke for the piston motion of the coils and coil bobbin without causing asynchronous displacement between the coil and corresponding magnetic gap.

The remainder is the same as in embodiment 1,2, so it is not repeated here.

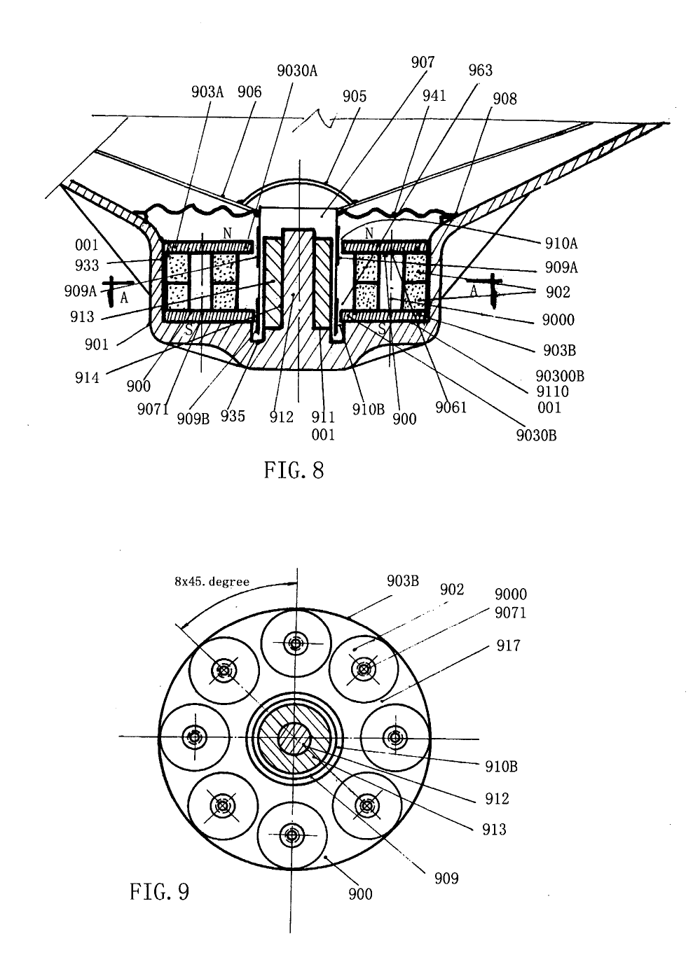

FIG. 8 shows the section view of the loudspeaker of the embodiment 7.

The structure of the frame 901 is similar to that of the frame 201 of the embodiment 2 which cannot be repeated here.

The structure of the magnetic paths of the loudspeakers in embodiment 7 and 2 are different. The upper pole plate 903A and the lower pole plate 903B are two coaxial and symmetric round plates with a central shaft hole 910 at the center of the plate. 8 sets of uniformly spaced permanent magnets are provided on the outer peripheries of the upper and lower pole plates with each set of magnets formed by lamination in series of two annular ferrite permanent magnets of the same projected areas, volumes and magnetic characteristics. Each annular ferrite permanent magnet has the same thickness and diameter of the shaft hole. 8 through holes 9061 of the upper pole plate 903A and 8 threaded holes 9071 of the lower pole plate 903B (not shown) are matched with shaft holes. Using 8 non-magnetic fasteners 9000 (such as copper bolt) to apply uniform static pressure in advance to the upper pole plate 903A, lower pole plate 902b and the engaged face 900 of 8 sets laminated annular permanent magnets the outer core of the integral magnetic path is formed. Embedding the core of the magnetic path from the outer side of frame 901 to the recess fitting face 933, the outer vertical face of the core and outer face 90300B of the lower pole plate 903B are bound by adhesive 00 1 with the recess fitting face933 and the annular flat face 9110 of frame respectively. An annular magnetic body 913 is mounted on the inner cylindrical body 912 on the axial position of the convex boss face 911 of the frame 901 . . . thus two uniform annular magnetic gaps 910A and 910B are formed between the inner vertical faces of the central shaft holes 910 of the upper pole plate 903A and lower pole plate 903B and the outer periphery of the annular magnetic body 913. Dual coil 909A and 909B are wound on a cylindrical coil bobbin 907 which are bound together with the damper 941, diaphragm 906 and coil bobbin 907. The structure principle of operation and effect are the same as in embodiment 1 and 2, which will not be repeated here.

FIG. 9 shows the plan section view of the magnetic path A-A of the embodiment 7.

The upper pole plate 903a and lower pole plate 903B of the loudspeaker are two coaxial and symmetric round plates made of magnetic material with a central hole 910 in the center and 8 through holes 9061 (upper pole plate) and 8 threaded holes 9071(lower pole plate) uniformly provided along the periphery of the central hole. The angle between the adjacent two through holes or the angle of the axes of the threaded holes is 45 degree. 8 sets of annular permanent magnets fitted with the through holes 9061 and threaded holes 9071 are uniformly spaced between the inner faces 900 of the upper and lower pole plates, and convection path 917 is provided between two adjacent sets of permanent magnets. The rest is similar to that of the embodiments 1,2, so it is not repeated here.

In order to improve ventilation a vent or grid may be provided with correspondence with the convection path 917.

Combination of the outer core of the magnetic path with the bracket and annular magnetic body of the embodiment 1 shown in FIG. 1, and at the same time assembly of the traditional frame of transducer (such as the conical bracket of the loudspeaker or the diaphragm of the hemisphere-top alt loudspeaker and its frame) on the outer boss face 90300A of the upper pole plate 903A allow to construct transducers with round plates.

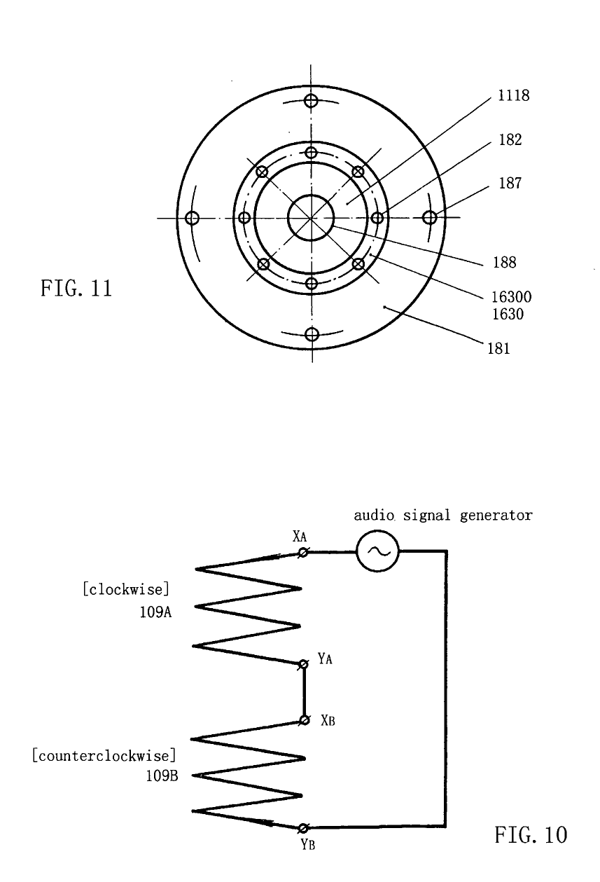

FIG. 10 shows the wiring scheme of the circuit of the transducer with resistance local characteristics.

The embodiment is described according to the embodiment 1 and FIG. 1 and FIG. 2.

The requirements of the embodiment are:

The materials and geometry of the upper pole plate 103A and lower pole plate 103A are similar, the geometry and the magnetic induction intensity Br of the two annular magnetic gaps 110A and 110B are identical, dual coil 109A and 109B are wound in opposite directions, the section areas of the wiring of the coils are equal to each other, the turns of dual coil are the same Na=Nb, and the absolute values of the inductance of dual coil are identical |L109A|=|L109B|. That is to say, with the section line X-X axis at the axial high of the permanent magnet 102 as the horizontal symmetric axis (ref to FIG. 1), the transducer has a pair of symmetric magnetic paths and coil circuit in geometry and magnetic characteristics.

Connected in series the rear and YA of the coil 109A and the head and YB of the coil 109B, the said real end and head end constitute a pair of signal input terminals of the transducer, Since the dual coil 109A and 109B operate in same flux loop, their inductance vectors are cancelled due to the 180 degree phase difference with the electro-dynamic force of the coil F=F109A+F109B, Therefore, the distortion and counter-electromotive force of the phase of the transducer with resistance load characteristics can be eliminated.

The symmetric circuit of the embodiment and the principle of setting the symmetric magnetic path can be applied to all the embodiments of the invention, by combination of various magnetic paths and circuits. Person with ordinary skill in the art can obtain the transducer with various structures and resistance load (or approximately) characteristics according to the invention.

FIG. 11 is the plan view of the bracket of the embodiment 1 of the invention.

The bracket is provided with a shaft hole 188 on the outer side of which a coaxial annular inner convex boss face 1118 in formed. A coaxial annular concave groove 1630 is provided on the outer side of boss face 1118 and at the bottom 1630 of the concave groove 8 uniformly spaced bracket holes 182 are formed. When the coil bobbin 107 of the transducer vibrates up and downward, the holes 182 reduce the damping of the bobbin and improve ventilation of the coil. A coaxial mounting surface 1800 of the bracket is formed on the outer side of the annular concave groove 1650 which is a smooth annular mounting surface engaged with the outer boss face 10300B of the lower pole plate. On the mounting surface 1800 4 through holes 182 are uniformly spaced which fix the bracket 181 on the lower pole plate with the help of bolts (ref to embodiment 1 of FIG. 1, it ignore repeated here).

The similar brackets 281 . . . 1181 of the embodiment can be matched with any type of the magnetic path of the transducer to construct various drivers of the transducer.

FIG. 12 shows the plan and perspective view of the collar of embodiment 1.

In the embodiment the collar 137 of the driver is composed of two semi-circular plastic sections. Adhesive 001 is applied to the inner face 138 of the collar which then is bound to the upper pole plate 103A, lower pole plate 103B, and the outer vertical face of the permanent magnet 102. In order to correspond with the magnetic path of FIG. 1 and improve ventilation of the transducer, two rectangular vents 140 are formed on each collar 137 which match the convection air holes 117 provided on the periphery pole shoes 129A and 129B of the upper and lower pole plates. Adhesive 001 is applied to the coupling face of two collars. Arrow Fin indicates the direction of static pressure during assembling of the driver of the transducer.

The remainder portions can be found in embodiment 1 and 2, thus they are omitted here.

The similar collars of driver 237 . . . 1137 of the embodiment can be matched with any type of the magnetic path of the transducer and form various drivers of the transducer.

FIG. 13 shows the plan and perspective view of the collar of the embodiment 2 of the invention.

It has a square pole plate and the structure of the magnetic path is the same as embodiment 4 in FIG. 5. The collar of the driver is formed by a strip-like collars 237. Adhesive is applied to the inner face of the collar and the coupling face of the adjacent collar. An arrow Fin indicates the direction of the static pressure applied to the collar. In order to improve ventilation of the loudspeaker a vent 240 can be formed on each collar which matches with the convection hole 517 of the pole plate in embodiment 4 of FIG. 5.

The remainder is similar to that of the embodiment 1 and 2, it is not repeated here.

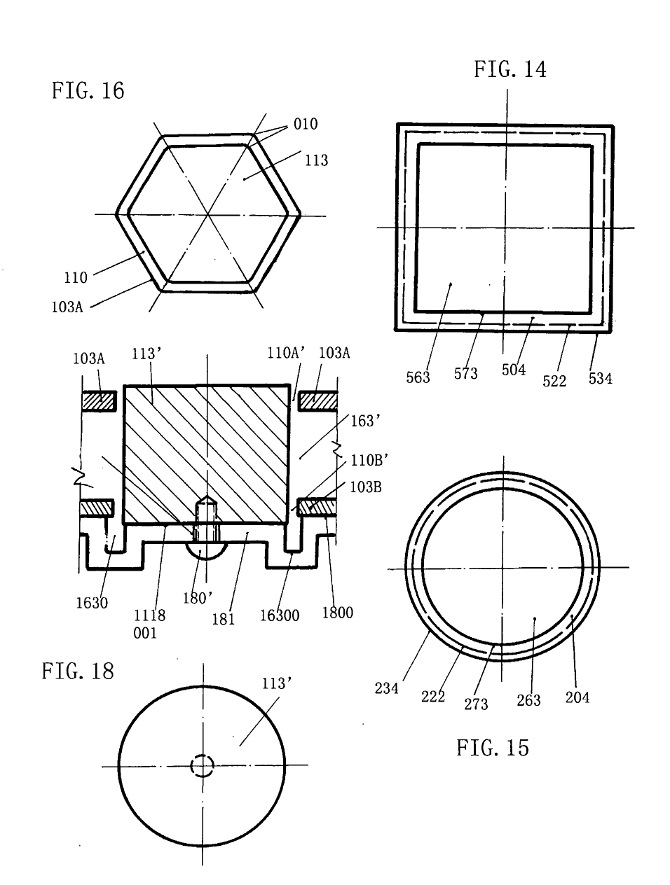

FIG. 14 shows a plan view of an embodiment of the hollow frame of the invention.

The square hollow frame 504 is pressure-cast by non-magnetic materials, such as rigid plastics. The frame is provided with an outer face 534 which is engaged and bound with the inner face of the upper and lower pole plates. An outer vertical face 522 is provided on the middle portion of the outer face which is engaged and bound with the inner vertical face of the permanent magnet 502. The structure space 563 is formed between the smooth vertical inner face 573 and the annular magnetic body of the transducer or it's outer periphery. The rest can be referred to the embodiments 1 and 2, as well as FIG. 2, FIG. 5 and FIG. 6, etc.

FIG. 15 shows a plan view of the hollow frame of the invention.

The annular hollow frame 204 is fitted with the embodiment 2 of FIG. 2, and it is not repeated here.

FIG. 16 shows a plan view of an embodiment of the hexagonal magnetic gap.

The cylindrical magnetic body 113 of the transducer of the embodiment is a cylindrical pole plate with hexagonal section. The upper pole plate and lower pole plate hole 103 is a hexagonal hole matched with the cylindrical magnetic body 113, thus a hexagonal annular magnetic gap 110 is formed. Since the hexagon's side length is maximum, thus compared with the coil (not shown) are able to gain the maximum electro—dynamic force and ventilation effect. From FIG. 17 it can be seen, that a short symmetric arc 010 is provided on the top of inner corner of each hexagon (or square) which is tangential to the two sides of the inner corner with its center located on dividing line of the inner corner.

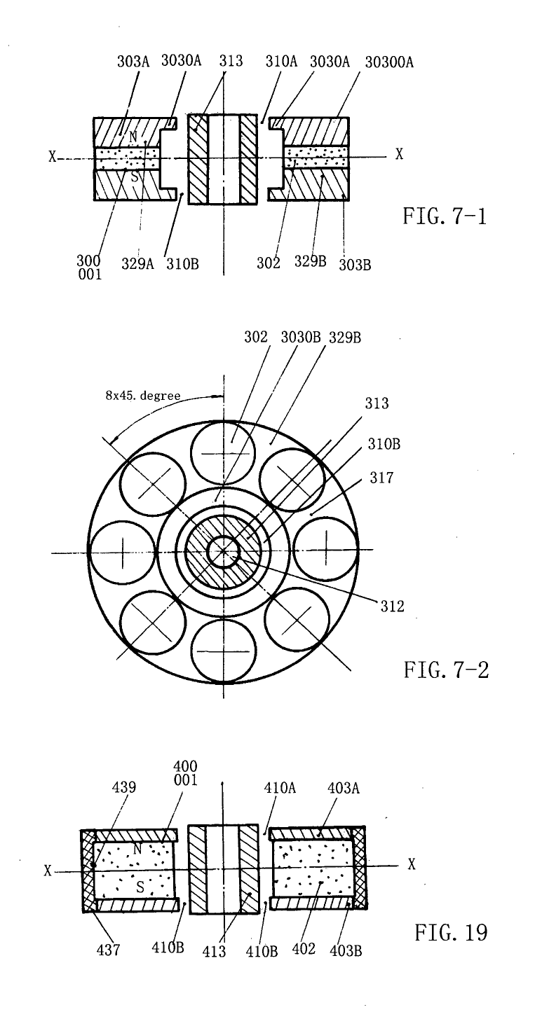

FIG. 18 shows a schematic plan and perspective view of the nodes of an embodiment of the cylindrical magnetic body.

Compared with FIG. 1 of embodiment 1 it can be seen that a cylindrical magnetic body 113′ has replaced the annular one 113 and the body 113′ is mounted on the inner convex boss face 118 of the bracket 181 by bolt 180′ passing through the hole 188 of the bracket and adhesive 001. The cylindrical magnetic body 113′ and the hole 110 of the upper and lower pole plates form two annular magnetic gaps 110A′ and 110B′. The rest portions can be referred to the embodiments 1 and 2, thus it is not repeated here.

FIG. 19 shows the longitudinal plan of the magnetic path according to embodiment 8 of the invention.

The upper pole plate 403A and the lower pole plate 403B are two coaxial and symmetrically arranged round plates with a round shaft hole provided on the central portion thereof. A coaxially mounted circular ferrite permanent magnet 402 is fixed between the pole faces 400 of the round plate with adhesive. Dual annular magnetic gaps 410A and 410B are formed between the outer vertical surface of a coaxially mounted annular magnetic body 413 and the inner face of the shaft hole of the round plate. Said upper and lower pole plates, permanent magnet, and the annular magnetic body are integrated to a integral magnetic path of the transducer by said frame 401 or said bracket 481.

The rest portions can be referred to the embodiments 1 and 2, thus it is not repeated here.

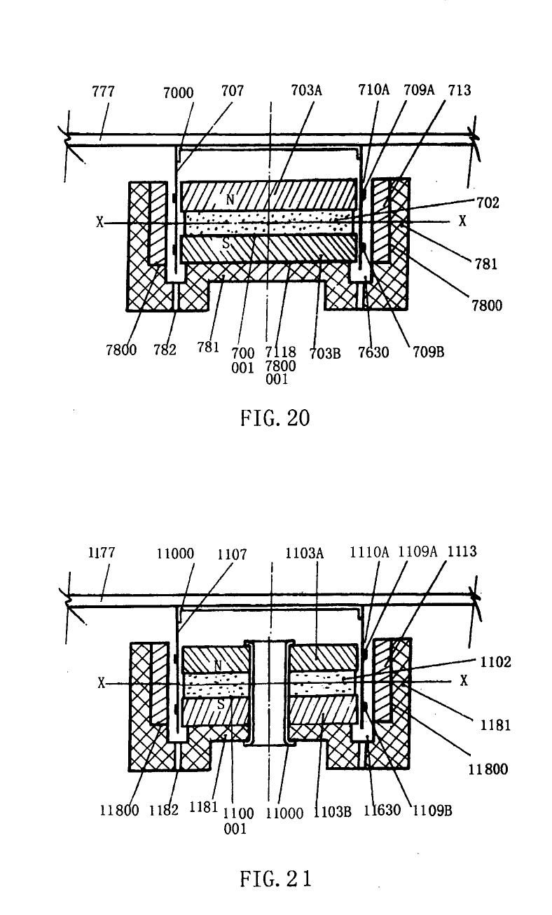

FIG. 20 shows the longitudinal plan of the magnetic path and the bracket according to embodiment 9 of the invention.

The upper pole plate 703A and lower pole plate 703B of the loudspeaker are two round plates without shaft hole. A coaxially mounted circular ferrite permanent magnet 702 is fixed between the pole faces 400 of the round plate with adhesive. Said round plate and permanent magnet are enclosed by a coaxial mounted annular magnetic body 713 and said dual annular magnetic gaps 710A and 710B are formed between the inner vertical face of the annular magnetic body and the outer vertical face of the round plates. A inner convex boss face 7118 is formed on the central portion of a bracket 781 of engineering plastic coaxial mounted with round plate 703, neodymium magnet 702, and annular magnetic body 713. An annular concave groove 7630 is provided on the outer side of the said inner convex boss face 7118. A coaxial annular concave groove 7630 is formed on the outer side of the said inner convex boss face 7188, and a coaxial mounting face of the bracket engaged with the outer face 7800 of the lower pole plate and a collar of driver or outer face of the lower end of said annular magnetic body 713 is provided on the outer side of the said annular concave groove 7630; In the present embodiment, the annular magnetic body 713 is flush mounted on the vertical mounting face of the bracket 781 and fixed with adhesive, which round plate 703B is fixed with inner convex boss face 7188 of the bracket with adhesive.

A coil bobbin 707 is inserted into said annular magnetic gap 710 wound with said coils 709A and 709B. The outer end face of a damper (not shown) is fixed to the upper end face of the bracket outside the upper end portion of the annular magnetic body with adhesive. The inner end face of the damper is fixed to coil bobbin with adhesive. An annular coupling plate 7000 of engineering plastic is fixed to the inner side of the top of the coil bobbin with the outer level of the annular coupling plate 7000 fixed to a flat panel acoustic radiator 777 so that a flat panel acoustic radiator driver with dual coil and dual magnetic gap is formed. It has a pair of magnetic paths and circuits symmetric to the axis x-x (please refer to descriptions of embodiments represented by FIGS. 1, 2, 10) so the loudspeaker has resistance load characteristics. Additionally, the flat panel acoustic radiator driver of the present embodiment has greater axial stroke and transient response. In the case that two of four of the flat panel acoustic radiator drivers according to the present invention are connected either in series, in parallel, or in combination of them, the problem of asynchronous working status of multipoint drivers caused by inductance or differences of inductance in the conventional plat panel acoustic radiator can be overcome, thus greatly improving the degree of distortion, sensibility, and lowering the lower limit of bass frequency. The rest portions can be referred to the embodiments 1 and 2, thus it is not repeated here.

FIG. 21 is the longitudinal plan of the magnetic path according to embodiment 10 of the invention.

The upper pole plate 1103A and lower pole plate 1103B of the loudspeaker are to coaxial and symmetric round plates provided with a round shaft hole on the central portion thereof. A coaxially mounted circular ferrite permanent magnet 1102 is fixed between the pole faces 1100 of the round plate with adhesive. Dual annular magnetic gaps 1110A and 1110B are formed between the outer vertical surface of a coaxially mounted annular magnetic body 1113 and the inner face of the shaft hole of the round flat plate. A round non-magnetic fastener 11000 is inserted into the shaft holes of the round plate and permanent magnet to rivet the round plate and the permanent magnet to the central shaft hole of the outer inwardly concave face of the bracket 1181.

The rest portions can be referred to the embodiments 1 and 2, thus it is not repeated here.

It should be noted that combination of all the magnetic paths shown in FIG. 1-FIG. 21, different permanent magnets, different frame and brackets, annular and cylindrical magnetic body of different section shapes and different connecting circuits of the coils of transducer can form different kinds of transducers. All of these modifications are included in the invention.

### INDUSTRIAL APPLICATION

The main advantages of the mechanic-electrical transducer of the invention are as follows:

1. Adhesive may not be used between the upper and lower pole plates as well as the pole faces of the permanent magnet. Thus the assembly technology has been simplified, the magnetic resistance is reduced and the problem of disconnection and “chucking” of coils caused by vortex heating is avoided.

2. High fidelity. The electric audio transducer with resistance load characteristic can be realized which is capable of significant increase the output voice level at the low frequency and high-frequency end of the transducer, eliminating the phase distortion and counter-electromotive force of the transducer and decreasing the distortion of resonance wave.

3. High sensitivity. In the condition of the same diameter and material and technological level, the efficiency of the transducer is increased by 2-16 times with comparison of the traditional ones.

4. It is possible to manufacture transducer with long or extreme long strokes.

5. Small volume, simple construction and high ratio of performance to price, easy to mass production.

### OTHER EMBODIMENTS

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the scope of the following claims

1. A transducer with dual coil and dual magnetic gap comprising a magnetic path of permanent magnet and a frame integral with it, two coaxial annular magnetic gaps of the same diameters and a coil bobbin inserted in the magnetic gaps on which the insulated wiring is paralleled wound to form dual coil, a diaphragm connected with a damper and a coil bobbin is conical-shaped or spherical-shaped or a flat panel acoustic radiator, the diaphragm is vibrated in the air to produce sound by piston motion of the coil bobbin, or variations of sound pressure are detected by the diaphragm and audio voltage signals are induced in coils, which is characterized in that:
upper and lower pole plates of said magnetic path are two coaxial and symmetric inwardly concave plates made of magnetic material on the outer central portion of which a boss face is provided with a shaft hole which usually is a round hole, but can also be a square or hexagonal hole;
convex peripheral pole shoes are formed on the inner peripheries of said upper and lower pole plates, and a piece or more of the permanent magnets uniformly spaced with equal thickness and axial magnetization is provided between the pole faces of two peripheral pole shoes;
a hollow frame of non-magnetic material is embedded and bound to the inner face of the concave plates of said upper and lower pole plates with the inner vertical face of the permanent magnet mounted and bounded to the inner vertical face of the hollow frame and adhesive securing;
two pole faces of said permanent magnet are engaged with two pole faces of the peripheral pole shoes of the upper and lower pole plates, and a outer core of an integral magnetic path is formed by means of through holes formed on said boss faces of the upper and lower pole plates and non-magnetic fasteners, or by means of the static pressure by the upper and lower pole plates and adhesive applied to the engaging pole faces during the course of assembling;
two coaxial annular magnetic gaps of the same diameter are formed between the outer periphery of the annular or cylindrical magnetic body coaxial with the central hole of the inner concave plates of the upper and lower pole plates and the vertical periphery of the central holes of the upper and lower pole plates;
said coils and the central hole of said round plate are matched with said annular or cylindrical magnetic body, with its optimum section being regular hexagon and a short symmetric are provided on the top of inner corners of the regular hexagon or square while the arc is tangential to both sides of the inner corner and its center is located on the dividing line of the inner corner;
a frame made of non-magnetic materials coaxial with said magnetic path is formed to provide a base structure for said upper pole plate, permanent magnet, lower pole plate, and cylindrical magnetic body so that they are integrated as a whole part;
said two coaxial coils are inserted into said annular magnetic gaps, while wound direction of the dual coil and the direction of current produce an electrodynamic force F in the coils in the same moment and same direction;
with the dividing bisectrix x-x of half the axial highness of said permanent magnet as the horizontal symmetric axis said transducer with dual coil and dual magnetic gap has the symmetric magnetic path in geometry and magnetic characteristics, also the dual coil have opposite wound directions after connecting in series while the section area of the wiring of the dual coil, their turns and absolute value of the inductance are equal to each other with said transducer being a mechanic-electrical transducer with resistance load characteristics.

2. The transducer with dual coil and dual magnetic gap according to claim 1 is characterized in that said upper and lower pole plates are two round inner concave plates, and said permanent magnet is an annular permanent magnet or more than a piece of uniformly spaced sectorial or circular or annular rare metal permanent magnet.

3. The transducer with dual coil and dual magnetic gap according to claim 1 is characterized in that said upper and lower pole plates are two square inner concave plates and the permanent magnet is 4 pieces of uniformly spaced strip-like rare-metal permanent magnet with the same thickness.

4. The transducer with dual coil and dual magnetic gap according to any of claim 1 through 3, which is characterized in that more than two uniformly spaced inner concave convection holes are provided on the periphery pole shoes of the upper and lower pole plates with the deepest bottom leveled with the inner face of the said inner concave plate.

5. The transducer with dual coil and dual magnetic gap according to any of claim 1 through 3, which is characterized in that:
a frame of non-magnetic material is coaxially connected with said magnetic path with a coaxial open cylinder provided on the waist of the frame;
a coaxial annular concave groove is formed on the inner face of the bottom of said cylinder with two coaxial annular boss faces provided on the inner and outer sides of said annular groove;
an inner convex cylinder of non-magnetic material is provided on the axial position of the middle annular boss face to fix the annular magnetic body on said cylinder;
a non-magnetic annular connecting plate closes the vertical faces of the upper and lower pole plates, to embed the integral core of said magnetic path to the inner fitting face of the frame cylinder forming a integral unit with the frame.

6. The transducer with dual coil and dual magnetic gap according to claim 5 is characterized in that said frame is made of aluminum alloy or engineering plastics.

7. The transducer with dual coil and dual magnetic gap according to any of claim 1 through claim 3 is characterized in that:
the upper and lower pole plates and the vertical outer periphery of the permanent magnet are closed by two or more than two collars of driver made of non-magnetic material;
the inner face of the collar and the pole plates as well as the vertical outer face of the permanent magnet are engaged with each other and bound together as a whole part;
a bracket of non-magnetic material is coaxially connected with said magnetic path, with a an inner convex boss face in the central portion, in which an central axial hole may be formed;
an coaxial annular concave groove is formed on the outer side of the said inner convex boss face, and a coaxial mounting face of the bracket engaged with the outer face of the lower pole plate and a collar of driver or outer face of the lower end of said annular magnetic body is provided on the outer side of the said annular concave groove;
a coaxial annular or cylindrical magnetic body is mounted on the axial position of the said boss face by a set of non-magnetic fasteners, or said upper and lower pole plates and said permanent magnet are mounted on the axial position of the said boss face by fasteners made of non-magnetic materials or adhesive;
two coaxial annular magnetic gaps of the same diameters are formed between the outer periphery of the annular cylindrical magnetic body and the vertical periphery of the central hole of the upper and lower pole plates, thus forming a complete magnetic path of the driver of the transducer with dual coil and dual magnetic gap.

8. The transducer with dual coil and dual magnetic gap according to claim 7 is characterized in that said collar of driver and said bracket is made of aluminum alloy or engineering plastics.

9. A transducer with dual coil and dual magnetic gap comprising a magnetic path of permanent magnet and a frame integral with it, two coaxial annular magnetic gaps of the same diameters and a coil bobbin inserted in the magnetic gap on which the insulated wiring is paralleled wound to form dual coil, a diaphragm connected with a damper and a coil bobbin is conical-shaped or spherical-shaped or a flat panel acoustic radiator, the diaphragm is vibrated in the air to produce sound by piston motion of the coil bobbin, or variations of sound pressure are detected by the diaphragm and audio voltage signals are induced in coils, which is characterized in that:
upper and lower pole plates of said magnetic path are two coaxial and symmetric inwardly concave plates made of magnetic material on the outer central portion of which a boss face is provided with a shaft hole which usually is a round hole, or can be a square or hexagonal hole;
convex peripheral pole shoes are formed on the inner peripheries of said upper and lower pole plates, and a piece or more of the permanent magnets uniformly spaced with equal thickness and axial magnetization is provided between the pole faces of two peripheral pole shoes;
a hollow frame of non-magnetic material is embedded and bound to the inner face of the concave plates of said upper and lower pole plates with the inner vertical face of the permanent magnet mounted and bounded to the inner vertical face of the hollow frame and adhesive securing;
two pole faces of said permanent magnet are engaged with two pole faces of the peripheral pole shoes of the upper and lower pole plates, and a outer core of an integral magnetic path is formed by means of through holes formed on said boss faces of the upper and lower pole plates and non-magnetic fasteners, or by means of the static pressure by the upper and lower pole plates and adhesive applied to the engaging pole faces during the course of assembling;
two coaxial annular magnetic gaps of the same diameter are formed between the outer periphery of the annular or cylindrical magnetic body coaxial with the central hole of the inner concave plates of the upper and lower pole plates and the vertical periphery of the central holes of the upper and lower pole plates;
said coils and the central hole of said round plate are matched with said annular or cylindrical magnetic body, with its optimum section being regular hexagon and a short symmetric are provided on the top of inner corners of the regular hexagon or square while the arc is tangential to both sides of the inner corner and its center is located on the dividing line of the inner corner;
a frame made of non-magnetic materials coaxial with said magnetic path is formed to provide a base structure for said upper pole plate, permanent magnet, lower pole plate, and cylindrical magnetic body so that they are integrated as a whole part;
said two coaxial coils are inserted into said annular magnetic gap, while wound direction of the dual coil and the direction of current produce an electrodynamic force F in the coils in the same moment and same direction.

10. The transducer with dual coil and dual magnetic gap according to claim 9 is characterized in that said upper and lower pole plates are two round inner concave plates, and said permanent magnet is an annular permanent magnet or more than a piece of uniformly spaced sectorial or circular or annular rare metal permanent magnet.

11. The transducer with dual coil and dual magnetic gap according to claim 9 is characterized in that said upper and lower pole plates are two square inner concave plates and the permanent magnet is 4 pieces of uniformly spaced strip-like rare-metal permanent magnet with the same thickness.

12. The transducer with dual coil and dual magnetic gap according to any of claim 9 through 11, which is characterized in that more than two uniformly spaced inner concave convection holes are provided on the periphery pole shoes of the upper and lower pole plates with the deepest bottom leveled with the inner face of the said inner concave plate.

13. The transducer with dual coil and dual magnetic gap according to any of claim 9 through 11, which is characterized in that:
a frame of non-magnetic material is coaxially connected with said magnetic path with a coaxial open cylinder provided on the waist of the frame;
a coaxial annular concave groove is formed on the inner face of the bottom of said cylinder with two coaxial annular boss faces provided on the inner and outer sides of said annular groove;
an inner convex cylinder of non-magnetic material is provided on the axial position of the middle annular boss face to fix the annular magnetic body on said cylinder;
a non-magnetic annular connecting plate closes the vertical faces of the upper and lower pole plates, to embed the integral core of said magnetic path to the inner fitting face of the frame cylinder forming a integral unit with the frame.

14. The transducer with dual coil and dual magnetic gap according to claim 13 is characterized in that said frame is made of aluminum alloy or engineering plastics.

15. The transducer with dual coil and dual magnetic gap according to any of claim 9 through claim 11 is characterized in that:
the upper and lower pole plates and the vertical outer periphery of the permanent magnet are closed by two or more than two collars of driver made of non-magnetic material;
the inner face of the collar and the pole plates as well as the vertical outer face of the permanent magnet are engaged with each other and bound together as a whole part;
a bracket of non-magnetic material is coaxially connected with said magnetic path, with a an inner convex boss face in the central portion, in which an central axial hole may be formed;
an coaxial annular concave groove is formed on the outer side of the said inner convex boss face, and a coaxial mounting face of the bracket engaged with the outer face of the lower pole plate and a collar of driver or outer face of the lower end of said annular magnetic body is provided on the outer side of the said annular concave groove;
a coaxial annular or cylindrical magnetic body is mounted on the axial position of the said boss face by a set of non-magnetic fasteners, or said upper and lower pole plates and said permanent magnet are mounted on the axial position of the said boss face by fasteners made of non-magnetic materials or adhesive;
two coaxial annular magnetic gaps of the same diameters are formed between the outer periphery of the annular cylindrical magnetic body and the vertical periphery of the central hole of the upper and lower pole plates, thus forming a complete magnetic path of the driver of the transducer with dual coil and dual magnetic gap.

16. The transducer with dual coil and dual magnetic gap according to claim 15 is characterized in that said collar of driver and said bracket is made of aluminum alloy or engineering plastics.

17. A transducer with dual coil and dual magnetic gap comprising a magnetic path of permanent magnet and a frame integral with it, two coaxial annular magnetic gaps of the same diameters and a coil bobbin inserted in the magnetic gaps on which the insulated wiring is paralleled wound to form dual coil, a diaphragm connected with a damper and a coil bobbin is conical-shaped or spherical-shaped or a flat panel acoustic radiator, the diaphragm is vibrated in the air to produce sound by piston motion of the coil bobbin, or variations of sound pressure are detected by the diaphragm and audio voltage signals are induced in coils, which is characterized in that:
upper and lower pole plates of said magnetic path are two coaxial and symmetric round plates made of magnetic material;
said round plates can be provided with a shaft hole which usually is a round hole, but can also be a square or hexagonal hole;
one piece or more of the permanent magnets uniformly spaced with equal thickness and axial magnetization is provided between said upper pole plate and lower pole plate;
two coaxial annular magnetic gap of the same diameter are formed between the periphery of the annular or cylindrical magnetic body coaxial with the central axis of the upper and lower pole plates and the vertical periphery of the central holes of the upper and lower pole plates;
said coils and the central hole of said round plate are matched with said annular or cylindrical magnetic body, with its optimum section being regular hexagon and a short symmetric are provided on the top of inner corners of the regular hexagon or square while the arc is tangential to both sides of the inner corner and its center is located on the dividing line of the inner corner;
a frame made of non-magnetic materials coaxial with said magnetic path is formed to provide a base structure for said upper pole plate, permanent magnet, lower pole plate, and cylindrical magnetic body so that they are integrated as a whole part;
said two coaxial coils are inserted into said annular magnetic gap and arranged at certain intervals, while wound direction of the dual coil and the direction of current produce an electrodynamic force F in the coils in the same moment and same direction;
with the dividing bisectrix x-x of half the axial highness of said permanent magnet as the horizontal symmetric axis said transducer with dual coil and dual magnetic gap has the symmetric magnetic path in geometry and magnetic characteristics, also the dual coil have opposite wound directions after connecting in series while the section area of the wiring of the dual coil, their turns and absolute value of the inductance are equal to each other with said transducer being a mechanic-electrical transducer with resistance load characteristics.

18. The transducer with dual coil and dual magnetic gap according to claim 17 is characterized in that:
said annular or cylindrical magnetic body are enclosed by said permanent magnet;
a shaft hole is formed on the central portion of each of said upper and lower pole plates, three or more sets of uniformly spaced permanent magnets of the same thickness are provided on the outer periphery of the central hole of the said upper and lower pole plates, each set of which is formed by 2 annular permanent magnets laminated in series and magnetized axially;
four pole faces of each set of permanent magnets are directly engaged with two pole faces of the upper and lower pole plates;
a outer core of an integral magnetic path is formed by means of through holes formed on the axial position of said annular permanent magnets of the upper and lower pole plates and non-magnetic fasteners, or by means of the static pressure by the upper and lower pole plates and adhesive applied to the engaging pole faces during the course of assembling.

19. The transducer with dual coil and dual magnetic gap according to claim 17 is characterized in that:
said upper and lower pole plates are inwardly concave plates with a shaft hole formed on the central portion of each of the said upper and lower pole plates;
convex peripheral pole shoes are formed on the inner peripheries of said upper and lower pole plates, and a piece of annular permanent magnet or more pieces of sectorial or circular or annular rare metal permanent magnets uniformly spaced with equal thickness and axial magnetization are provided between the pole faces of two peripheral pole shoes;
two pole faces of said permanent magnet are engaged with two pole faces of the upper and lower pole plates;
and a outer core of an integral magnetic path is formed by means of through holes formed on said upper and lower pole plates and non-magnetic fasteners, or by means of the static pressure by the upper and lower pole plates and adhesive applied to the engaging pole faces during the course of assembling.

20. The transducer with dual coil and dual magnetic gap according to claim 17 is characterized in that:
said annular or cylindrical magnetic body are enclosed by said permanent magnet;
a shaft hole is formed on the central portion of each of said upper and lower pole plates, a piece of annular permanent magnet or more pieces of sectorial or circular or annular rare metal permanent magnets uniformly spaced with equal thickness and axial magnetization are provided on the outer periphery of the central hole of the said upper and lower pole plates;
two pole faces of said permanent magnet are engaged with two pole faces of the upper and lower pole plates;
a outer core of an integral magnetic path is formed by means of through holes formed on the upper and lower pole plates and non-magnetic fasteners, or by means of the static pressure by the upper and lower pole plates and adhesive applied to the engaging pole faces during the course of assembling.

21. The transducer with dual coil and dual magnetic gap according to claim 17 is characterized in that:
said permanent magnet are enclosed by said annular magnetic body;
said upper and lower pole plates are two round plates without shaft holes;
a piece of annular permanent magnet or more pieces of sectorial or circular or annular rare metal permanent magnets uniformly spaced with equal thickness and axial magnetization are provided between the upper and lower pole plates;
two pole faces of said permanent magnet are engaged with two pole faces of the upper and lower pole plates;
a inner core of an integral magnetic path is formed by means of through holes formed on said upper and lower pole plates and non-magnetic fasteners, or by means of the static pressure by the upper and lower pole plates and adhesive applied to the engaging pole faces during the course of assembling.

22. The transducer with dual coil and dual magnetic gap according to claim 17 is characterized in that:
said permanent magnet are enclosed by said annular magnetic body;
said upper and lower pole plates are two round plates shaft holes formed on the central portion of each of said upper and lower pole plates;
a piece of annular ferrite or rare metal permanent magnets between the upper and lower pole plates;
two pole faces of said permanent magnet are engaged with two pole faces of the upper and lower pole plates;
a inner core of an integral magnetic path is formed by means of through holes formed on said upper and lower pole plates and non-magnetic fasteners, or by means of the static pressure by the upper and lower pole plates and adhesive applied to the engaging pole faces during the course of assembling.

23. The transducer with dual coil and dual magnetic gap according to any of claim 17 through claim 22 is characterized in that:
a frame of non-magnetic material is coaxially connected with said magnetic path with a coaxial open cylinder provided on the waist of the frame;
a coaxial annular concave groove is formed on the inner face of the bottom of said cylinder with two coaxial annular boss faces provided on the inner and outer sides of said annular groove;
an inner convex cylinder of non-magnetic material is provided on the axial position of the middle annular boss face to fix the annular magnetic body on said cylinder;
a non-magnetic annular connecting plate closes the vertical faces of the upper and lower pole plates, to embed the integral core of said magnetic path to the inner fitting face of the frame cylinder forming a integral unit with the frame.

24. The transducer with dual coil and dual magnetic gap according to claim 23 is characterized in that said frame is made of aluminum alloy or engineering plastics.

25. The transducer with dual coil and dual magnetic gap according to any of claim 17 through claim 22 is characterized in that:
the upper and lower pole plates and the vertical outer periphery of the permanent magnet are closed by two or more than two collars of driver made of non-magnetic material;
the inner face of the collar and the pole plates as well as the vertical outer face of the permanent magnet are engaged with each other and bound together as a whole part;
a bracket of non-magnetic material is coaxially connected with said magnetic path, with a an inner convex boss face in the central portion, in which an central axial hole may be formed;
an coaxial annular concave groove is formed on the outer side of the said inner convex boss face, and a coaxial mounting face of the bracket engaged with the outer face of the lower pole plate and a collar of driver or outer face of the lower end of said annular magnetic body is provided on the outer side of the said annular concave groove;
a coaxial annular or cylindrical magnetic body is mounted on the axial position of the said boss face by a set of non-magnetic fasteners, or said upper and lower pole plates and said permanent magnet are mounted on the axial position of the said boss face by fasteners made of non-magnetic materials or adhesive;
two coaxial annular magnetic gaps of the same diameters are formed between the outer periphery of the annular cylindrical magnetic body and the vertical periphery of the central hole of the upper and lower pole plates, thus forming a complete magnetic path of the driver of the transducer with dual coil and dual magnetic gap.

26. The transducer with dual coil and dual magnetic gap according to claim 25 is characterized in that said collar of driver and said bracket is made of aluminum alloy or engineering plastics.

27. A transducer with dual coil and dual magnetic gap comprising a magnetic path of permanent magnet and a frame integral with it, two coaxial annular magnetic gaps of the same diameters and a coil bobbin inserted in the magnetic gap on which the insulated wiring is paralleled wound to form dual coil, a diaphragm connected with a damper and a coil bobbin is conical-shaped or spherical-shaped or a flat panel acoustic radiator, the diaphragm is vibrated in the air to produce sound by piston motion of the coil bobbin, or variations of sound pressure are detected by the diaphragm and audio voltage signals are induced in coils, which is characterized in that:
upper and lower pole plates of said magnetic path are two coaxial and symmetric round plates made of magnetic material;
said round plates can be provided with a shaft hole which usually is a round hole, but can also be a square or hexagonal hole;
one piece or more of the permanent magnets uniformly spaced with equal thickness and axial magnetization is provided between said upper pole plate and lower pole plate;
two coaxial annular magnetic gaps of the same diameter are formed between the periphery of the annular or cylindrical magnetic body coaxial with the central axis of the upper and lower pole plates and the vertical periphery of the central holes of the upper and lower pole plates;
said coils and the central hole of said round plate are matched with said annular or cylindrical magnetic body, with its optimum section being regular hexagon and a short symmetric are provided on the top of inner corners of the regular hexagon or square while the arc is tangential to both sides of the inner corner and its center is located on the dividing line of the inner corner;
a frame made of non-magnetic materials coaxial with said magnetic path is formed to provide a base structure for said upper pole plate, permanent magnet, lower pole plate, and cylindrical magnetic body so that they are integrated as a whole part;
said two coaxial coils are inserted into said annular magnetic gap and arranged at certain intervals, while wound direction of the dual coil and the direction of current produce an electrodynamic force F in the coils in the same moment and same direction.

28. The transducer with dual coil and dual magnetic gap according to claim 27 is characterized in that:
said annular or cylindrical magnetic body are enclosed by said permanent magnet;
a shaft hole is formed on the central portion of each of said upper and lower pole plates, three or more sets of uniformly spaced permanent magnets of the same thickness are provided on the outer periphery of the central hole of the said upper and lower pole plates, each set of which is formed by 2 annular permanent magnets laminated in series and magnetized axially;
four pole faces of each set of permanent magnets are directly engaged with two pole faces of the upper and lower pole plates;
a outer core of an integral magnetic path is formed by means of through holes formed on the axial position of said annular permanent magnets of the upper and lower pole plates and non-magnetic fasteners, or by means of the static pressure by the upper and lower pole plates and adhesive applied to the engaging pole faces during the course of assembling.

29. The transducer with dual coil and dual magnetic gap according to claim 27 is characterized in that:
said upper and lower pole plates are inwardly concave plates with a shaft hole formed on the central portion of each of the said upper and lower pole plates;
convex peripheral pole shoes are formed on the inner peripheries of said upper and lower pole plates, and a piece of annular permanent magnet or more pieces of sectorial or circular or annular rare metal permanent magnets uniformly spaced with equal thickness and axial magnetization are provided between the pole faces of two peripheral pole shoes;
two pole faces of said permanent magnet are engaged with two pole faces of the upper and lower pole plates;
and a outer core of an integral magnetic path is formed by means of through holes formed on said upper and lower pole plates and non-magnetic fasteners, or by means of the static pressure by the upper and lower pole plates and adhesive applied to the engaging pole faces during the course of assembling.

30. The transducer with dual coil and dual magnetic gap according to claim 27 is characterized in that:
said annular or cylindrical magnetic body are enclosed by said permanent magnet;
a shaft hole is formed on the central portion of each of said upper and lower pole plates, a piece of annular permanent magnet or more pieces of sectorial or circular or annular rare metal permanent magnets uniformly spaced with equal thickness and axial magnetization are provided on the outer periphery of the central hole of the said upper and lower pole plates;
two pole faces of said permanent magnet are engaged with two pole faces of the upper and lower pole plates;
a outer core of an integral magnetic path is formed by means of through holes formed on the upper and lower pole plates and non-magnetic fasteners, or by means of the static pressure by the upper and lower pole plates and adhesive applied to the engaging pole faces during the course of assembling.

31. The transducer with dual coil and dual magnetic gap according to claim 27 is characterized in that:
said permanent magnet are enclosed by said annular magnetic body;
said upper and lower pole plates are two round plates without shaft holes;
a piece of annular permanent magnet or more pieces of sectorial or circular or annular rare metal permanent magnets uniformly spaced with equal thickness and axial magnetization are provided between the upper and lower pole plates;
two pole faces of said permanent magnet are engaged with two pole faces of the upper and lower pole plates;
a inner core of an integral magnetic path is formed by means of through holes formed on said upper and lower pole plates and non-magnetic fasteners, or by means of the static pressure by the upper and lower pole plates and adhesive applied to the engaging pole faces during the course of assembling.

32. The transducer with dual coil and dual magnetic gap according to claim 27 is characterized in that:
said permanent magnet are enclosed by said annular magnetic body;
said upper and lower pole plates are two round plates shaft holes formed on the central portion of each of said upper and lower pole plates;
a piece of annular ferrite or rare metal permanent magnets between the upper and lower pole plates;
two pole faces of said permanent magnet are engaged with two pole faces of the upper and lower pole plates;
a inner core of an integral magnetic path is formed by means of through holes formed on said upper and lower pole plates and non-magnetic fasteners, or by means of the static pressure by the upper and lower pole plates and adhesive applied to the engaging pole faces during the course of assembling.

33. The transducer with dual coil and dual magnetic gap according to any of claim 27 through claim 32 is characterized in that:
a frame of non-magnetic material is coaxially connected with said magnetic path with a coaxial open cylinder provided on the waist of the frame;
a coaxial annular concave groove is formed on the inner face of the bottom of said cylinder with two coaxial annular boss faces provided on the inner and outer sides of said annular groove;
an inner convex cylinder of non-magnetic material is provided on the axial position of the middle annular boss face to fix the annular magnetic body on said cylinder;
a non-magnetic annular connecting plate closes the vertical faces of the upper and lower pole plates, to embed the integral core of said magnetic path to the inner fitting face of the frame cylinder forming a integral unit with the frame.

34. The transducer with dual coil and dual magnetic gap according to claim 33 is characterized in that said frame is made of aluminum alloy or engineering plastics.

35. The transducer with dual coil and dual magnetic gap according to any of claim 27 through claim 32 is characterized in that:
the upper and lower pole plates and the vertical outer periphery of the permanent magnet are closed by two or more than two collars of driver made of non-magnetic material;
the inner face of the collar and the pole plates as well as the vertical outer face of the permanent magnet are engaged with each other and bound together as a whole part;
a bracket of non-magnetic material is coaxially connected with said magnetic path, with a an inner convex boss face in the central portion, in which an central axial hole may be formed;
an coaxial annular concave groove is formed on the outer side of the said inner convex boss face, and a coaxial mounting face of the bracket engaged with the outer face of the lower pole plate and a collar of driver or outer face of the lower end of said annular magnetic body is provided on the outer side of the said annular concave groove;
a coaxial annular or cylindrical magnetic body is mounted on the axial position of the said boss face by a set of non-magnetic fasteners, or said upper and lower pole plates and said permanent magnet are mounted on the axial position of the said boss face by fasteners made of non-magnetic materials or adhesive;
two coaxial annular magnetic gaps of the same diameters are formed between the outer periphery of the annular cylindrical magnetic body and the vertical periphery of the central hole of the upper and lower pole plates, thus forming a complete magnetic path of the driver of the transducer with dual coil and dual magnetic gap.

36. The transducer with dual coil and dual magnetic gap according to claim 35 is characterized in that said collar of driver and said bracket is made of aluminum alloy or engineering plastics.
